(19) United States
(12) Patent Application Publication
(10) Pub. No.: US 2026/0300130 A1
(43) Pub. Date: Oct. 1, 2026

(54) GRAPH-BASED MODELS WITH TELEMETRY NODES

(71) Applicant: Infosys Limited, Bangalore (IN)

(72) Inventor: Steven SCHILDERS, Columbus, IN (US)

(73) Assignees: Infosys Limited, Bangalore (IN); InvertIT Inc., Columbus, IN (US)

(21) Appl. No.: 19/094,425

(22) Filed: Mar. 28, 2025

(30) Foreign Application Priority Data
Mar. 28, 2025 (IN) 202541030071

(51) Int. Cl. G06F 11/3604

(52) U.S. Cl. CPC G06F 11/3612

(57) ABSTRACT

An overlay system is provided that includes a storage element and processing circuitry coupled thereto. The storage element stores an executable graph-based model that includes a plurality of active nodes and a plurality of master telemetry nodes. The processing circuitry, based on a stimulus, identifies, from the plurality of active nodes, a first active node. The processing circuitry determines a first master telemetry node of the plurality of master telemetry nodes associated with the first active node. The processing circuitry further retrieves, based on the first master telemetry node, a telemetry dataset from the first active node. The processing circuitry, based on the first master telemetry node and the telemetry dataset, determines a set of telemetry insights associated with the first active node. The set of telemetry insights is indicative of one or more operational parameters associated with the overlay system.

### FIELD OF THE DISCLOSURE

Various embodiments of the present disclosure relate generally to graph-based models. More specifically, various embodiments of the present disclosure relate to implementation of telemetry nodes in executable graph-based models.

### BACKGROUND

Graph-based models are widely used for representing complex relationships between real-world entities. These models typically include vertices that represent entities and edges that define associations between them. Due to their ability to capture intricate connections, graph-based models have found applications in various domains, including social networks, recommendation systems, knowledge graphs, bioinformatics, cybersecurity, and real-time analytics.

The performance of various systems implemented by way of graph-based models is inherently influenced by operational performance of the graph-based models. Effective utilization of the graph-based models requires continuous performance evaluation to ensure optimal functionality, efficiency, and responsiveness. This necessitates analyzing operational parameters such as computational efficiency, memory usage, query processing speed, structural integrity, or the like, of the graph-based models. Such analysis is performed based on operational data extracted from the graph-based models.

However, extracting operational data from graph-based models is often time-consuming and computationally expensive. Typically, the analysis of the operational data is performed based on post-processing techniques or batch analysis, which introduces significant delays. In many time-sensitive applications, such as real-time fraud detection, network monitoring, or autonomous systems, delay in extraction and analysis of operational data poses a substantial challenge. Delayed insights can lead to degraded system performance, inefficient resource allocation, and missed critical events.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating implementation of telemetry nodes in executable graph-based models are provided substantially as shown in, and described in connection with, at least one of the figures.

The methods and systems described herein provide an overlay system. The overlay system includes processing circuitry and a storage element coupled to the processing circuitry. The storage element is configured to store an executable graph-based model that includes a plurality of active nodes and a plurality of master telemetry nodes. The processing circuitry is configured to receive a stimulus associated with the overlay system. Based on the stimulus, the processing circuitry is further configured to identify, from the plurality of active nodes, a first active node. The processing circuitry is further configured to determine a first master telemetry node of the plurality of master telemetry nodes associated with the first active node. The processing circuitry is further configured to retrieve, based on the first master telemetry node, a telemetry dataset from the first active node. The processing circuitry is further configured to determine, based on the first master telemetry node and the telemetry dataset, a set of telemetry insights associated with the first active node. The set of telemetry insights is indicative of one or more operational parameters associated with the overlay system.

In some embodiments, a node-type of the first master telemetry node is a combination of an edge node-type and an overlay node-type.

In some embodiments, the executable graph-based model further includes a plurality of telemetry operations overlay nodes. The processing circuitry is further configured to instantiate, based on the first master telemetry node, a first slave telemetry node, in the executable graph-based model, that represents the telemetry dataset associated with the first active node. The processing circuitry is further configured to identify a first telemetry operations overlay node of the plurality of telemetry operations overlay nodes of the executable graph-based model. The first telemetry operations overlay node is identified based on a functionality thereof being in conformity with the stimulus. The processing circuitry is further configured to associate the first telemetry operations overlay node with the first slave telemetry node. The set of telemetry insights is determined further based on the first telemetry operations overlay node and the first slave telemetry node.

In some embodiments, the first active node is one of: a vertex node, an edge node, an overlay node, or a role node. The first slave telemetry node is one of: a vertex telemetry node, an edge telemetry node, an overlay telemetry node, or a role telemetry node. Based on the first active node being the vertex node, the first slave telemetry node is the vertex telemetry node. Based on the first active node being the edge node, the first slave telemetry node is the edge telemetry node. Based on the first active node being the overlay node, the first slave telemetry node is the overlay telemetry node. Based on the first active node being the role node, the first slave telemetry node is the role telemetry node.

In some embodiments, the first active node corresponds to a first composite node that includes a second active node and a third active node, of the plurality of active nodes.

In some embodiments, the telemetry dataset includes a first subset of telemetry dataset associated with the second active node and a second subset of telemetry dataset associated with the third active node.

In some embodiments, the executable graph-based model further includes a plurality of telemetry operations overlay nodes. The processing circuitry is further configured to instantiate, based on the first master telemetry node, a first slave telemetry node in the executable graph-based model. The first slave telemetry node corresponds to a second composite node that includes a second slave telemetry node that represents the first subset of telemetry dataset and a third slave telemetry node that represents the second subset of telemetry dataset. The processing circuitry is further configured to identify a first telemetry operations overlay node of the plurality of telemetry operations overlay nodes. The first telemetry operations overlay node is identified based on a functionality thereof being in conformity with the stimulus. The processing circuitry is further configured to associate, the first telemetry operations overlay node with the first slave telemetry node. The set of telemetry insights is determined further based on the first telemetry operations overlay node and the first slave telemetry node.

In some embodiments, the processing circuitry is further configured to associate the first telemetry operations overlay node with each of the second slave telemetry node and the third slave telemetry node. The set of telemetry insights is determined further based on the second slave telemetry node and the third slave telemetry node.

In some embodiments, the second active node is associated with a second master telemetry node of the plurality of master telemetry nodes. The set of telemetry insights is determined further based on the second master telemetry node.

In some embodiments, the first master telemetry node is further associated with a third master telemetry node of the plurality of master telemetry nodes. Based on the association of the first master telemetry node with the third master telemetry node, the first slave telemetry node is further associated with the third master telemetry node. The set of telemetry insights is determined further based on the third master telemetry node.

In some embodiments, the processing circuitry is further configured to generate an insight file based on the set of telemetry insights. The processing circuitry is further configured to store the insight file, in the storage element, in association with the first active node.

In some embodiments, the processing circuitry is further configured to instantiate an insight node in the executable graph-based model that represents the set of telemetry insights.

In some embodiments, the executable graph-based model further includes a plurality of standard operations overlay nodes. The processing circuitry is further configured to determine a first standard operations overlay node, of the plurality of standard operations overlay nodes, associated with the first master telemetry node. The set of telemetry insights is determined further based on the first standard operations overlay node.

In some embodiments, the executable graph-based model further includes a plurality of standard operations overlay nodes. The processing circuitry is further configured to determine a second standard operations overlay node, of the plurality of standard operations overlay nodes, associated with the first active node. The set of telemetry insights is determined further based on the second standard operations overlay node.

In some embodiments, the first master telemetry node is one of: a public access node, a private access node, or a protected access node.

In some embodiments, the processing circuitry is further configured to determine a fourth master telemetry node of the plurality of master telemetry nodes associated with the first active node. The set of telemetry insights is determined further based on the fourth master telemetry node.

In some embodiments, the processing circuitry is further configured to determine a second active node of the plurality of active nodes based on the stimulus. The first master telemetry node is further associated with the second active node. The set of telemetry insights is determined further based on the second active node.

In some embodiments, the first active node is a generic node and the first master telemetry node is a generic master telemetry node.

In some embodiments, the processing circuitry is further configured to determine, based on the stimulus, whether at least one of the first active node or the first master telemetry node is unloaded from the executable graph-based model. The processing circuitry is further configured to load at least one of the first active node or the first master telemetry node in the executable graph-based model based on at least one of the first active node or the first master telemetry node being unloaded from the executable graph-based model.

In some embodiments, the first active node corresponds to a run-time node that includes (i) a node template that defines a node structure and (ii) a node instance that is an implementation of the node template. Based on the first active node being the run-time node, the first master telemetry node corresponds to a run-time master telemetry node that includes (i) a telemetry node template that defines a telemetry node structure and (ii) a telemetry node instance that is an implementation of the telemetry node template.

In some embodiments, the run-time node is loaded based on loading of the node template and the node instance, and run-time master telemetry node is loaded based on loading of the telemetry node template and the telemetry node instance.

In some embodiments, a method is provided. The method comprising, receiving, by processing circuitry of an overlay system, a stimulus associated with the overlay system. An executable graph-based model is stored in a storage element of the overlay system. The executable graph-based model includes a plurality of active nodes and a plurality of master telemetry nodes. The method further comprising, identifying, by the processing circuitry, from the plurality of active nodes, a first active node based on the stimulus. The method further comprising, determining, by the processing circuitry, a first master telemetry node of the plurality of master telemetry nodes associated with the first active node. The method further comprising, retrieving, by the processing circuitry, based on the first master telemetry node, a telemetry dataset from the first active node. The method further comprising, determining, by the processing circuitry, based on the first master telemetry node and the telemetry dataset, a set of telemetry insights associated with the first active node. The set of telemetry insights is indicative of one or more operational parameters associated with the overlay system.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic node within the executable graph-based model, consistent with disclosed embodiments of the present disclosure;

FIG. 3B is a block diagram that illustrates a standard structure of a run-time node within the executable graph-based model, consistent with disclosed embodiments of the present disclosure;

FIG. 4A is a block diagram that illustrates a standard structure of a generic telemetry node within the executable graph-based model, consistent with disclosed embodiments of the present disclosure;

FIG. 4B is a block diagram that illustrates a standard structure of a run-time telemetry node within the executable graph-based model, consistent with disclosed embodiments of the present disclosure;

FIG. 5A is a block diagram that illustrates an executable generic telemetry node within the executable graph-based model, consistent with disclosed embodiments of the present disclosure;

FIG. 5B is a block diagram that illustrates an executable run-time telemetry node within the executable graph-based model, consistent with disclosed embodiments of the present disclosure;

FIG. 6 is a block diagram that illustrates a composition of the executable generic telemetry node that enables persistent storage of data and processing logic associated therewith, consistent with disclosed embodiments of the present disclosure;

FIG. 7 illustrates a graph that depicts implementation of a plurality of telemetry nodes in the executable graph-based model, consistent with disclosed embodiments of the present disclosure;

FIG. 8 illustrates a graph that depicts implementation of the plurality of telemetry nodes in conjunction with composite nodes of the executable graph-based model, consistent with disclosed embodiments of the present disclosure;

FIG. 9 shows an example computing system for carrying out methods of the present disclosure, consistent with disclosed embodiments of the present disclosure;

FIG. 10 illustrates a flowchart of a method for implementing the plurality of telemetry nodes in the executable graph-based model, consistent with disclosed embodiments of the present disclosure; and

FIG. 11 illustrates a flowchart of a method for determining a set of telemetry insights, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Graph-based models serve as a fundamental approach to representing intricate relationships among real-world entities. These models consist of vertices, which signify entities, and edges that establish associations between them. Their capability to effectively capture complex interconnections makes them well-suited for a wide range of applications, including social networking, recommendation engines, knowledge graphs, bioinformatics, cybersecurity, and real-time data processing.

The efficiency of various systems built using graph-based models is largely dependent on operational performance of the graph-based models. To ensure seamless functionality, resource optimization, and high responsiveness, continuous monitoring, and evaluation of the graph-based models are essential. Such evaluation involves assessing operational parameters, including processing efficiency, memory consumption, query execution speed, and graph structure consistency, among others. The basis for this evaluation is extraction of operational data from the graph-based models. Furthermore, as the complexity and scale of graph-based models increase, so does the need for efficient monitoring mechanisms that can adapt to dynamic changes in data relationships. For example, real-time knowledge graphs or cybersecurity threat detection systems require instant updates and reconfiguration based on evolving datasets, further emphasizing the importance of effective operational performance analysis.

The process of obtaining the operational data from the graph-based models is often resource-intensive and time-consuming. Typically, post-processing or batch analysis is used for such analysis of the operational data, which inherently introduces latency. In applications where real-time decision-making is critical—such as fraud detection, network security monitoring, and autonomous systems—delays in operational data extraction and analysis can significantly impact performance. Such delays may result in inefficiencies, suboptimal resource utilization, the failure to detect crucial events in a timely manner, or the like. Additionally, the volume of data generated by the graph-based models can be immense, making conventional approaches impractical for large-scale implementations. As industries increasingly adopt real-time data-driven strategies, there is a growing demand for solutions that enable continuous, low-latency performance monitoring of graph-based models.

The present disclosure is directed to implementation of telemetry nodes in an executable graph-based model of an overlay system. The executable graph-based model is a customized hypergraph with hyper-edges that are realized by way of executable nodes. Each executable node is associated with a particular node-type. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features in the overlay system. Each overlay node is associated with one or more nodes (for example, a vertex node, an edge node, or the like) of the executable graph-based model and includes a corresponding processing logic that when executed implements a functionality thereof on the associated nodes. Hence, the processing logic is implemented within the executable graph-based model and is not required to be retrieved from any external system.

The overlay system disclosed herein facilitates implementation of telemetry nodes in the executable graph-based model. The executable graph-based model may include various active nodes (for example, edge nodes, vertex nodes, overlay nodes, role nodes) and master telemetry nodes. Each active node may have corresponding operational data that may be indicative of performance of the overlay system. An active node, with respect to which the performance of the overlay system is to be analyzed, is associated with a master telemetry node. To analyze the performance of the overlay system, the master telemetry node may retrieve a telemetry dataset from the associated active node. The telemetry dataset corresponds to the operational data of the active node. Subsequently, the master telemetry node may generate a slave telemetry node, in the executable graph-based model, that may represent the telemetry dataset retrieved from the active node. The master telemetry node may analyze the telemetry dataset to generate a set of telemetry insights. Alternatively, the master telemetry node may identify a telemetry operations overlay node of the executable graph-based model that may include processing logic, which when executed may analyze the telemetry dataset. The master telemetry node may associate the telemetry operations overlay node with the slave telemetry node. Based on an analysis of the telemetry dataset represented by the slave telemetry node, the set of telemetry insights is generated. The set of telemetry insights may be indicative of the performance of the overlay system. The set of telemetry insights may be used to determine and execute one or more measures for optimization of the performance of the overlay system.

The implementation of the telemetry nodes in the executable graph-based model allows for the performance of the overlay system to be analyzed in real-time or near real-time. Hence, the overlay system significantly eliminates challenges associated with extraction and analysis of operational data from graph-based models at node-level. Such analysis at the node-level enables the overlay system to optimize the performance thereof at the node level and ensure that each node benefits from the optimization. Additionally, the disclosed overlay system provides real-time performance monitoring, enhanced computational efficiency, and low-latency decision-making, making it highly suitable for time-sensitive applications such as fraud detection, cybersecurity, and autonomous systems. The overlay system enables instantaneous data extraction and continuous analysis, ensuring that insights are generated in real-time. By optimizing query execution, reducing computational overhead, and dynamically adapting to changes in graph structures, the overlay system enhances scalability and responsiveness, making it ideal for handling large-scale, complex datasets.

### FIGURE DESCRIPTION

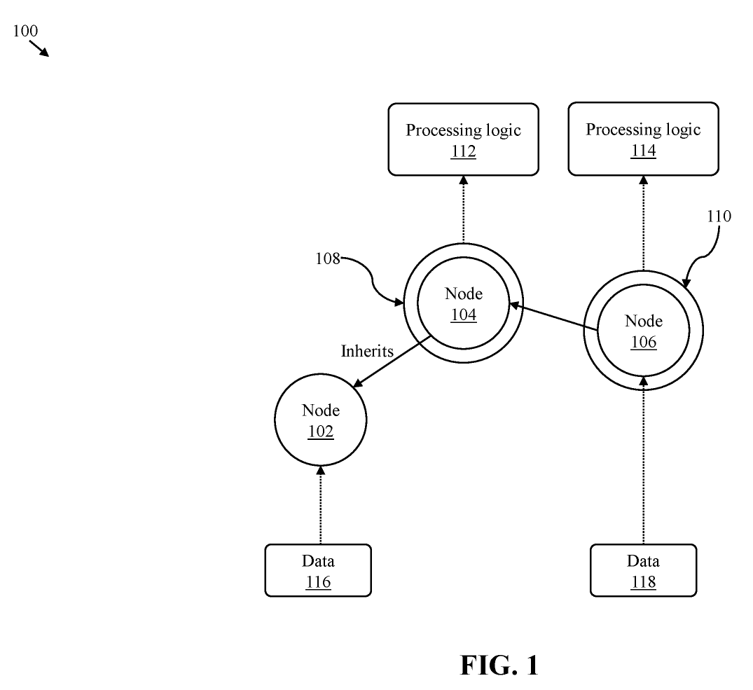

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At run-time, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

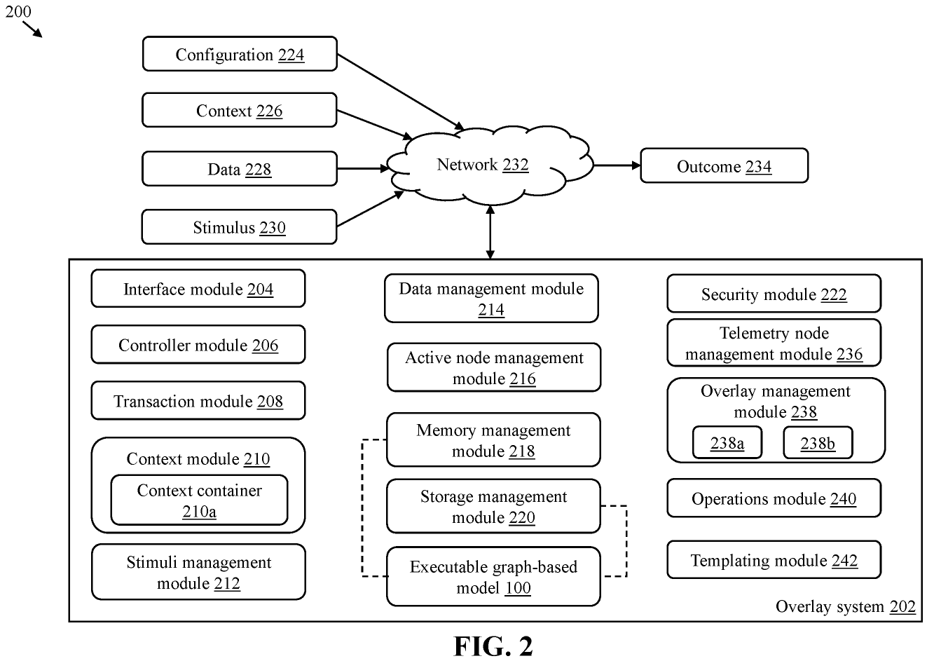

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a data management module 214, an active node management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes a telemetry node management module 236, an overlay management module 238, an operations module 240, and a templating module 242. In some embodiments, all the modules of the overlay system 202 except for the executable graph-based model 100 may collectively form processing circuitry that facilitates operations associated with a plurality of active nodes and a plurality of telemetry nodes of the executable graph-based model 100. The plurality of active nodes may include generic nodes and run-time nodes whereas the plurality of telemetry nodes may include master telemetry nodes and slave telemetry nodes.

A generic node may refer to a node, in the executable graph-based model 100, with an edge node-type, a role node-type, an overlay node-type, or a vertex node-type. A first generic node with the vertex node-type is coupled to a second generic node with the vertex node-type by way of a third generic node with the edge node-type indicative of roles of the first and second generic nodes. A generic node with an edge node-type is an edge node. A generic node with the vertex node-type is a vertex node. A generic node with the role node-type is a role node. A generic node with the overlay node-type is an overlay node. A run-time node may include a node template and a node instance. The node template may be a predefined node structure and the node instance may be an implementation of the predefined node structure. The node template and the node instance of the run-time node may have an edge node-type, a role node-type, an overlay node-type, or a vertex node-type. A first run-time node with the vertex node-type is coupled to a second run-time node with the vertex node-type by way of a third run-time node with the edge node-type indicative of roles of the first and second run-time nodes. The run-time node with the node template and the node instance having edge node-types is an edge node. The run-time node with the node template and the node instance having vertex node-types is a vertex node. The run-time node with the node template and the node instance having role node-types is a role node. The run-time node with the node template and the node instance having overlay node-types is an overlay node.

A master telemetry node of the plurality of telemetry nodes may refer to a node with a node-type that is a combination of an edge node-type and an overlay node-type. The master telemetry node, based on the edge node-type, may be associated with an active node. In addition, the master telemetry node, based on the overlay node-type, may include processing logic that when executed may retrieve a telemetry dataset from the associated active node. The telemetry dataset may correspond to operational data associated with the overlay system 202 with respect to the active node associated with the telemetry node. The master telemetry node may retrieve the telemetry dataset based on a set of telemetry parameters associated therewith. In some embodiments, the master telemetry node may further include processing logic that when executed may analyze the retrieved telemetry dataset to generate a set of telemetry insights that may be indicative of an operational performance of the overlay system 202. Notably, the operational performance of the overlay system 202 may correspond to individual and collective performance of one or more modules of the overlay system 202 to perform one or more tasks associated therewith. In some embodiments, the master telemetry node further includes processing logic that when executed may instantiate (namely, generate, create) a slave telemetry node in the executable graph-based model 100.

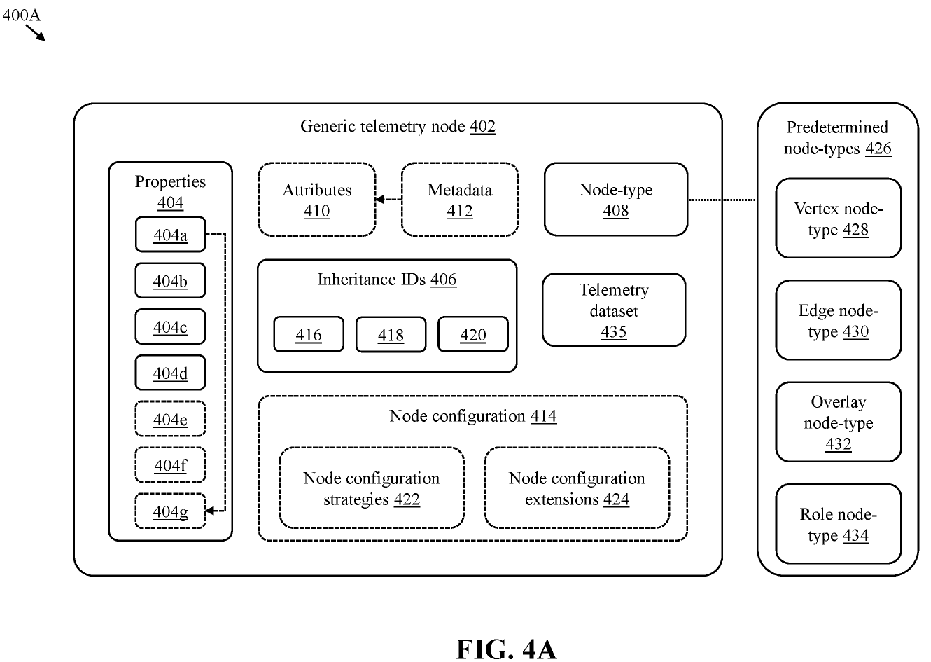

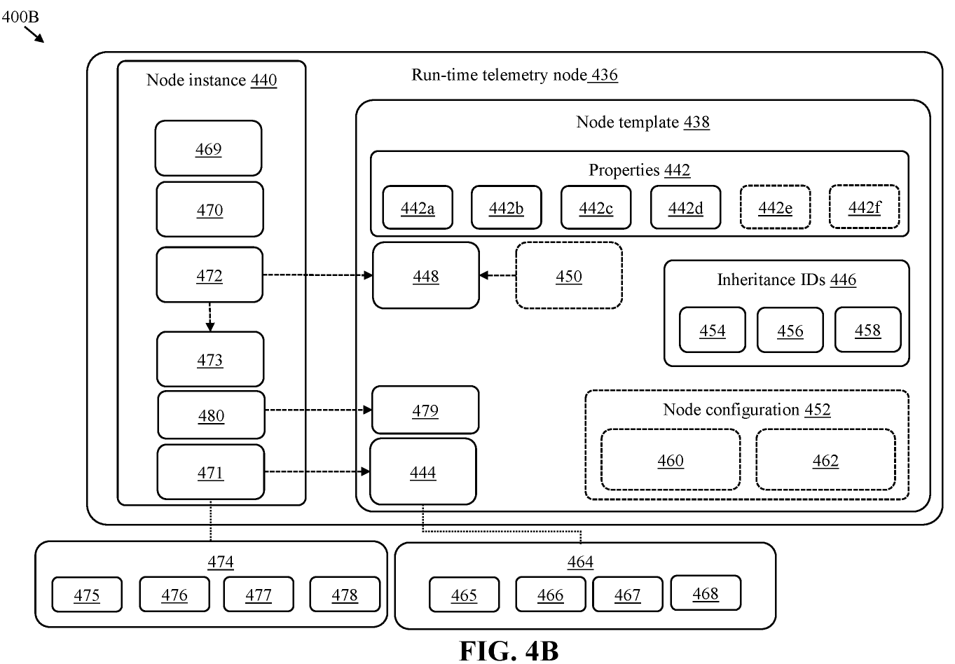

The slave telemetry node may be created in a first sub-graph of the executable graph-based model 100 that may be separate from a second sub-graph of the executable graph-based model 100 including the plurality of active nodes. The slave telemetry node may be created to represent the acquired telemetry dataset in the executable graph-based model 100. The slave telemetry node may have a node-type that may be the edge node-type, the vertex node, the role node-type, or the overlay node-type. The node-type of the slave telemetry node may depend on (i) the node-type of the active node or (ii) the acquired telemetry dataset. The slave telemetry node is described in detail in conjunction with FIGS. 4A and 4B. The telemetry node may be a generic telemetry node or a run-time telemetry node. Therefore, the master telemetry node may be a generic master telemetry node or a run-time master telemetry node whereas the slave telemetry node may be a generic slave telemetry node or a run-time slave telemetry node.

The term telemetry node is used throughout the description to refer, collectively, to the master telemetry node and the slave telemetry node. The term generic telemetry node is used throughout the description to refer, collectively, to the generic master telemetry node and the generic slave telemetry node. The term run-time telemetry node is used throughout the description to refer, collectively, to the run-time master telemetry node and the run-time slave telemetry node.

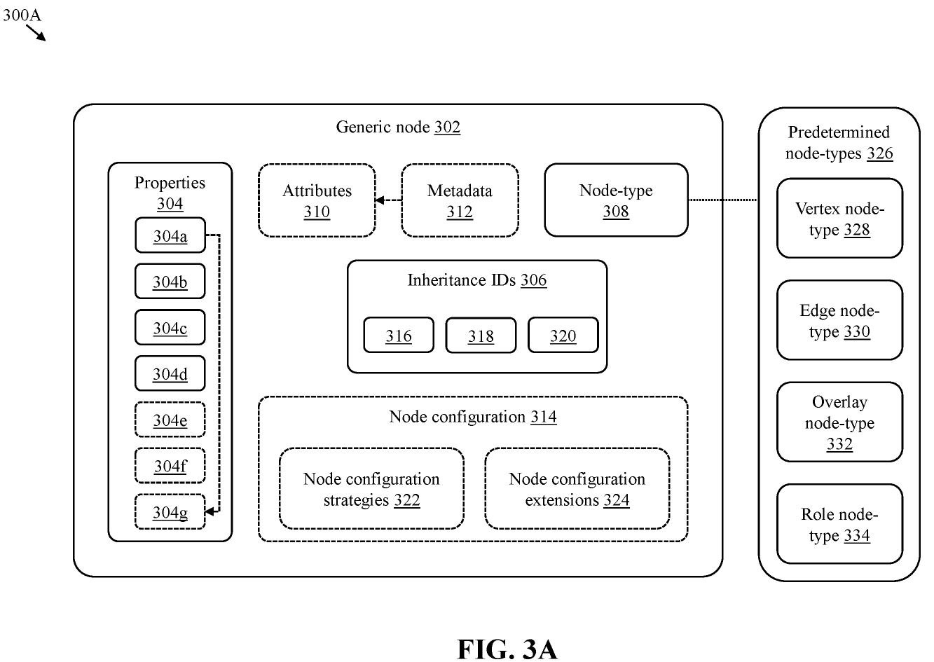

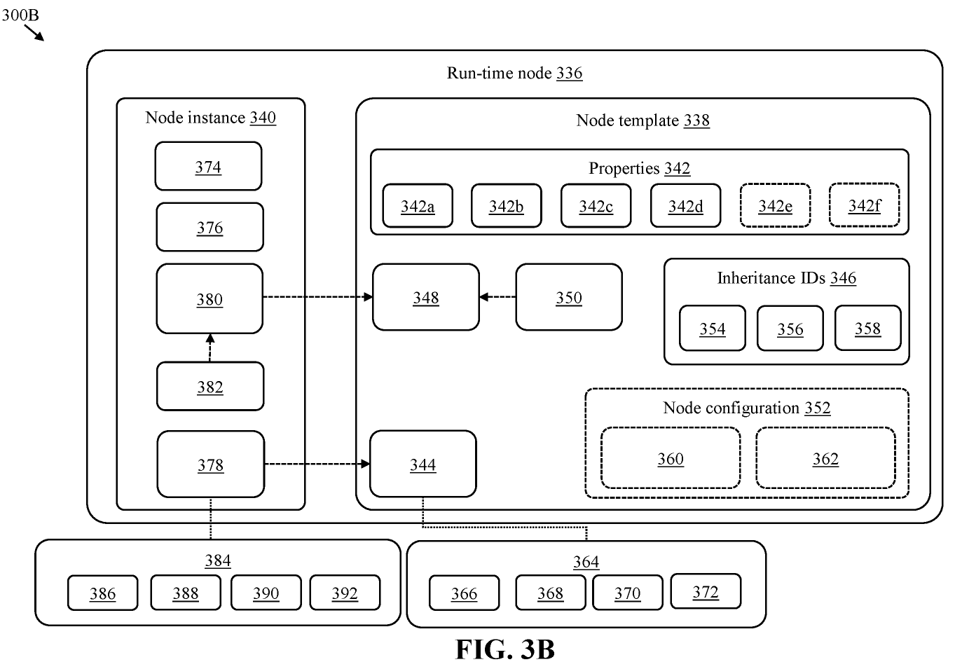

A standard structure of the generic node and the run-time node (as described later in conjunction with FIGS. 3A and 3B, respectively) may be modified to form the generic telemetry node (depicted in FIG. 4A) and the run-time telemetry node (depicted in FIG. 4B), respectively, in the executable graph-based model 100.

The overlay system 202 may include suitable logic, circuitry, interfaces, and/or code, executable by the circuitry, that may be configured to facilitate one or more operations associated with the nodes in the executable graph-based model 100. One or more modules (for example, the controller module 206, the transaction module 208, or the like) of the overlay system 202 may be modified and customized to execute one or more operations associated with the creation, utilization, and management of the plurality of telemetry nodes and execution of transactions associated with the telemetry nodes.

The interface module 204 may include suitable logic, circuitry, interfaces, and/or code, executable by the circuitry, configured to provide a common interface between internal modules of the overlay system 202 and/or external sources. The interface module 204 provides an application programming interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. Each defined context of the set of defined contexts pertains to a context that is associated with one or more operations for facilitating application and management of the plurality of nodes (for example, the active nodes) in the overlay system 202. That is to say that, one or more contexts of the set of defined contexts are indicative of the one or more operations to be executed by way of one or more active nodes in the overlay system 202. The one or more operations are executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 240 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the storage management module 220.

The active node management module 216 may include suitable logic, circuitry, interfaces, and/or code, executable by the circuitry, configured to manage, design, and implement the plurality of active nodes in the overlay system 202. The active nodes may include the generic nodes and the run-time nodes. Further, each active node may have a vertex node-type, an edge node-type, a role node-type, or an overlay node-type (described in conjunction with FIGS. 3A and 3B). Further, each active node may have a functionality associated therewith. The active node management module 216 is further configured to facilitate operations associated with execution of one or more transactions using the active nodes.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independently of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

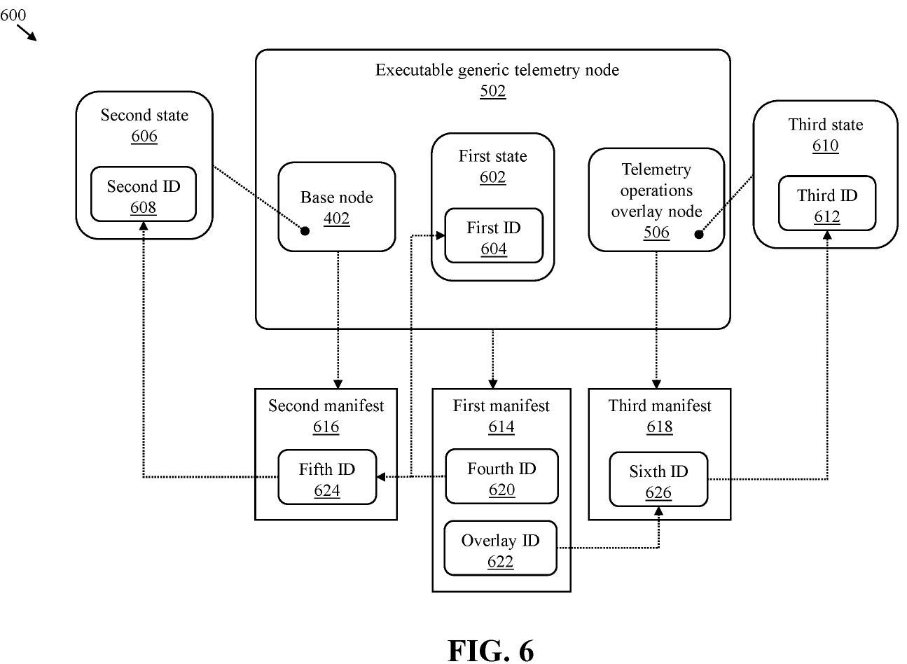

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage of manifest states (including manifest template states and manifest instance states) of the active nodes and the telemetry nodes. The storage element may include a primary storage and a secondary storage. The primary storage may store the executable graph-based model 100 and may also store the active nodes and the telemetry nodes that are loaded in the executable graph-based model 100. The secondary storage may store node states, manifests, and manifest states associated with nodes that are unloaded from the executable graph-based model 100. Storage and retrieval of active nodes are described in detail in conjunction with FIG. 6.

The security module 222 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 222 can implement one or more layers of data protection to ensure that the PII or PHI are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 238 and the telemetry node management module 236 for managing and executing security-based overlays and security-based operational functionalities associated with one or more telemetry nodes.

The telemetry node management module 236 may include suitable logic, circuitry, interfaces, and/or code, executable by the circuitry, configured to manage, store, and implement the plurality of telemetry nodes in the overlay system 202. The telemetry node management module 236 may be further configured to manage association between a telemetry node, of the plurality of telemetry nodes, and one or more active nodes of the plurality of active nodes. The telemetry node management module 236 may be further configured to manage association of a telemetry node with one or more remaining telemetry nodes of the plurality of telemetry nodes. The telemetry node management module 236 is further configured to facilitate operations associated with execution of one or more transactions using the telemetry nodes. The telemetry node management module 236 may be configured to enable a master telemetry node to retrieve telemetry datasets from one or more active nodes. The telemetry node management module 236 may be further configured to enable the master telemetry node to create one or more slave telemetry nodes that may represent the retrieved telemetry datasets. Further, the telemetry node management module 236 may be configured to enable the master telemetry node to perform one or more operations for analysis of the telemetry dataset being represented by the slave telemetry nodes.

The overlay management module 238 may include suitable logic, circuitry, interfaces, and/or code, executable by the circuitry, configured to manage all overlay nodes within the overlay system 202. The overlay nodes may be standard operations overlay nodes or telemetry operations overlay nodes.

The overlay management module 238 may include suitable logic, circuitry, interfaces, and/or code, executable by the circuitry, configured to manage all overlays (for example, the standard operations overlay nodes, the telemetry operations overlay nodes) within the overlay system 202. The overlays may be generic standard operations overlays, run-time standard operations overlays, generic telemetry operations overlays, or run-time telemetry operations overlays. The standard operations overlays are designed to facilitate execution of conventional and/or fundamental processes associated with the overlay system 202. For example, the standard operations overlays may be designed for encryption of active nodes, obfuscation of active nodes, auditing of active nodes, or the like. Standard operations overlays are associated with the active nodes and/or the telemetry nodes and extend functionality of the active nodes and/or telemetry nodes. A run-time standard operations overlay node is functionally same as the generic standard operations overlay node. In addition, the run-time standard operations overlay node may include a node template and a node instance. The telemetry operations overlays are designed to facilitate execution of operations associated with analysis of telemetry datasets. The telemetry operations overlays may perform such analysis based on a set of analysis parameters associated therewith.

Operations performed by the overlay management module 238 may include overlay storage management, overlay structure modeling, overlay logic creation and execution, and overlay loading and unloading (within the executable graph-based model 100). The overlay management module 238 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

Generic telemetry operations overlays and the run-time telemetry operations overlays are nodes that are designed to facilitate analysis of the active nodes. That is to say, the telemetry operations overlay nodes are designed to generate telemetry insights associated with the overlay system 202 based on telemetry dataset retrieved from associated active nodes. The run-time telemetry operations overlay node may have a description similar to the generic telemetry operations overlay node. In addition, the run-time telemetry operations overlay node may include a node template and a node instance.

Operations performed by the telemetry node management module 236 may further include overlay storage management, overlay structure modeling, overlay logic creation and execution, and overlay loading and unloading (within the executable graph-based model 100). The telemetry node management module 236 is communicatively coupled (e.g., connected either directly or indirectly) to one or more other modules (for example, the overlay management module 238, or the like) within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The overlay management module 238 may include a standard operations overlay management sub-module 238a and a telemetry operations overlay management sub-module 238b. The standard operations overlay management sub-module 238a is configured to perform operations of the overlay management module 238 that are associated with the generic standard operations overlays and run-time standard operations overlays. The telemetry operations overlay management sub-module 238b is configured to perform operations of the overlay management module 238 that are associated with the generic telemetry operations overlays and run-time telemetry operations overlays.

The operations module 240 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like) associated with the nodes (for example, the telemetry nodes) of the executable graph-based model 100.

The templating module 242 may include suitable logic, circuitry, interfaces, and/or code, executable by the circuitry, configured to enable the overlay system 202 to implement a templated version of one or more nodes (for example, the telemetry nodes, the overlay nodes, or the like) of the executable graph-based model 100. The templating module 242 may be configured to create one or more predefined templates in the executable graph-based model 100. The templating module 242 may be further configured to generate one or more node instances of the predefined node templates for the implementation of the templated version of the executable graph-based model 100. Notably, the templating module 242 ensures ontology integrity by enforcing structure and rules of a template when generating instances of the template at run-time. Ontology integrity refers to consistency, accuracy, and correctness of an ontology. Thus, the templating module 242 ensures that the consistency, accuracy, and correctness of the ontology of the executable graph-based model 100 are maintained while generating the instances of the template at run-time. The templating module 242 may be communicatively coupled (i.e., connected either directly or indirectly) to one or more nodes and/or one or more overlays within the executable graph-based model 100.

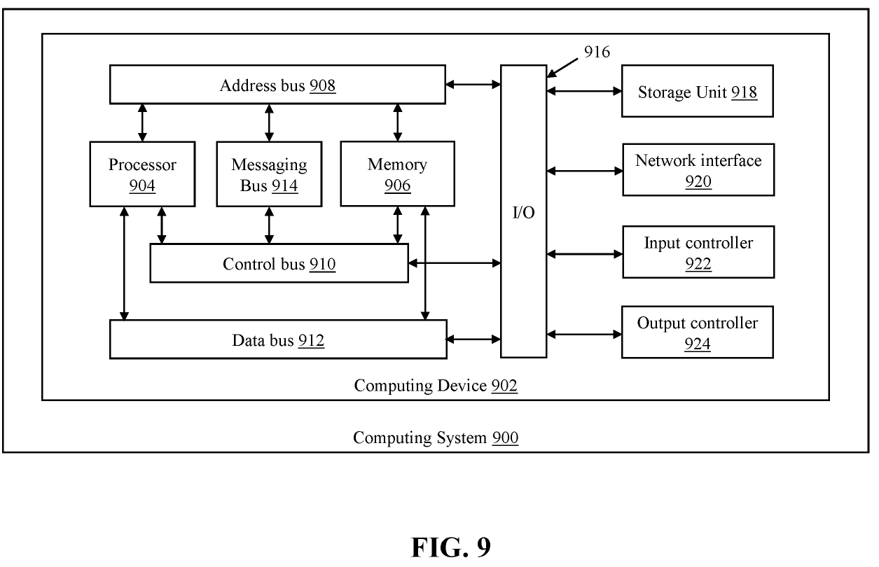

Beneficially, various features of the overlay system 202 support the processing circuitry and a computing system (shown in FIG. 9) implementing the overlay system 202 in significantly enhancing its performance. The significant enhancement in performance may include significantly increased throughput and efficiency, as well as significantly reduced cost complexity, processing complexity, time complexity, latency, waiting time, turnaround time, or the like.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model, specifically, the concept of a node. Unlike conventional graph-based systems, all elements (e.g., data, overlays, etc.) within the executable graph-based model 100 are implemented as nodes. As will become clear, this allows executable graph-based models to be flexible, extensible, and highly configurable.

FIG. 3A is a block diagram 300A that illustrates a standard structure of a generic node 302 within the executable graph-based model 100, consistent with disclosed embodiments of the present disclosure. Referring to FIG. 3A, the generic node 302 corresponds to a generic node of the executable graph-based model 100. The generic node 302 further corresponds to the core structure of the executable graph-based model 100 and forms the foundational building block for all data and processing logic within the executable graph-based model 100. The generic node 302 includes properties 304, inheritance IDs 306, and a node-type 308. The generic node 302 optionally includes one or more attributes 310, metadata 312 associated with the attributes 310, and a node configuration 314.

The properties 304 of the generic node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the generic node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the generic node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the generic node 302 is incremented when the generic node 302 undergoes transactional change. This allows the historical changes between versions of the generic node 302 to be tracked by modules or overlays within the overlay system 202. The namespace 304c of the generic node 302, along with the name 304d of the generic node 302, is used to help organize nodes within the executable graph-based model 100. That is, the generic node 302 is assigned a unique name 304d within the namespace 304c such that the name 304d of the generic node 302 need not be unique within the entire executable graph-based model 100, only within the context of the namespace 304c to which the generic node 302 is assigned. The generic node 302 optionally includes one or more icons 304e which are used to provide a visual representation of the generic node 302 when visualized via a user interface. The one or more icons 304e can include icons at different resolutions and display contexts such that the visualization of the generic node 302 is adapted to different display settings and contexts. The generic node 302 also optionally includes one or more labels 304f which are used to override the name 304d when the generic node 302 is rendered or visualized.

The generic node 302 supports the concept of inheritance of data and processing logic associated with any other node of the executable graph-based model 100 that is inherited by the generic node 302. This allows the behavior and functionality of the generic node 302 to be extended or derived from the inherited node of the executable graph-based model 100. The inheritance IDs 306 of the generic node 302 indicate the inheritance-based information, which may apply to the generic node 302. The inheritance IDs 306 comprise a set of Boolean flags that identify the inheritance structure of the generic node 302. The abstract flag 316 allows the generic node 302 to support the construct of abstraction. When the abstract flag 316 takes a value ‘true’, the generic node 302 is flagged as abstract that is to say that it cannot be instantiated or created within an executable graph-based model (e.g., the executable graph-based model 100). Thus, in an instance when the generic node 302 has the abstract flag 316 set to ‘true’, the generic node 302 may only form the foundation of other nodes that inherit therefrom. By default, the abstract flag 316 of the generic node 302 is set to ‘false’. The leaf flag 318 is used to indicate whether any other node may inherit from the generic node 302. If the leaf flag 318 is set to ‘true’, no other node may inherit from the generic node 302 (but unlike an abstract node, a node with the leaf flag 318 set may be instantiated and created within the executable graph-based model 100). The root flag 320 is used to indicate whether the generic node 302 inherits from any other node. If the root flag 320 is set to ‘true’, the generic node 302 does not inherit from any other node. The generic node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the generic node 302 is used to extend the functionality of the generic node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the generic node 302 and the node-type 308 are one logical unit that is not separated in the context of an executing system at run-time (e.g., in the context of execution of an executable graph-based model).

FIG. 3A further shows the plurality of predetermined node-types 326 which provides a non-exhaustive list of node-types for the node-type 308 associated with the generic node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node-types 326 further includes an overlay node-type 332 and a role node-type 334. As will be described in more detail below, a node with the overlay node-type 332 is used to extend the functionality of a node, such as the generic node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited.

The one or more attributes 310 correspond to the data associated with the generic node 302 (e.g., the data represented by the generic node 302 within the executable graph-based model 100 as handled by the data management module 214). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the generic node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the generic node 302 further includes the metadata 312 (e.g., data stored as a name, a confidentiality indicator for indicating data as sensitive and/or confidential, an average processing time required for processing data, or the like) which is associated with either the generic node 302 or an attribute (for example, the one or more attributes 310) of the generic node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, updating the data (e.g., the value) of this shared attribute will be reflected across both nodes.

The node configuration 314 provides a high degree of configurations for the different elements of the generic node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the generic node 302, which creates message source IDs. A further example of the concrete node configuration strategies 322 is a versioning strategy, associated with the configuration of the version ID 304b of the generic node 302, which supports major and minor versioning (depending on the type of transactional change incurred by the generic node 302). The versioning strategy may be adapted to a native filing system of a user device hosting the overlay system 202 or a third-party data storage (for example, Snowflake^{®}, or the like) associated with the overlay system 202. All attribute configurations are examples of node configuration extensions 324.

FIG. 3B is a block diagram 300B that illustrates a standard structure of a run-time node 336 within the executable graph-based model 100, consistent with disclosed embodiments of the present disclosure. Referring to FIG. 3B, the run-time node 336 corresponds to the core structure of the executable graph-based model 100 and forms the foundational building block for all data and processing logic within the executable graph-based model 100. The run-time node 336 is shown to include a node template 338 and a node instance 340. The node instance 340 is generated according to the node template 338. The node template 338 forms a data structure for the node instance 340. In other words, the node instance 340 is an implementation of the node template 338. The run-time node 336 shown in FIG. 3B is a compositional structure that is generated and executed, at run-time as part of the executable graph-based model 100. In other words, the node template 338 is defined as ‘offline’ and the node instance 340 and the run-time node 336 are run-time structures that are dynamically generated during execution of the executable graph-based model 100.

The node template 338 comprises a predetermined node structure. Further, the node template 338 defines one or more rules that govern the generation of the node instance 340. The node instance 340 is an implementation of the predefined node structure of the node template 338. In other words, the node instance 340 is generated based on the predetermined node structure and the one or more rules of the node template 338. The node template 338 cannot be modified during the execution but may be modified during offline mode or at rest. During execution, only the node instance 340 of the run-time node 336 may be modified.

The node template 338 includes properties 342, a node-type template 344, inheritance IDs 346, and a set of attribute templates 348. The node template 338 may optionally include metadata 350 and a node configuration 352. The properties 342 of the node template 338 include a unique identifier (ID) 342a, a version ID 342b, a namespace 342c, a name 342d, and optionally include one or more icons 342e and a set of labels 342f. The inheritance IDs 346 comprise an abstract flag 354, a leaf flag 356, and a root flag 358. The node configuration 352 optionally comprises one or more node configuration strategies 360 and/or one or more node configuration extensions 362.

FIG. 3B further shows a plurality of predetermined node-type templates 364 of the node-type template 344. The plurality of predetermined node-type templates 364 includes a vertex node-type template 366, an edge node-type template 368, an overlay node-type template 370, and a role node-type template 372. Further, the node instance 340 includes a unique ID 374, a version ID 376, a node-type instance 378, and a set of attribute instances 380. The node instance 340 may optionally include metadata 382. FIG. 3B further shows a plurality of predetermined node-type instances 384 of the node-type instance 378. The plurality of predetermined node-type instances 384 include a vertex node-type instance 386, an edge node-type instance 388, an overlay node-type instance 390, and a role node-type instance 392.

The unique ID 342a is unique for each node template within the executable graph-based model 100. Similarly, the unique ID 374 is unique for each node instance within the executable graph-based model 100. The unique ID 342a and the unique ID 374 are used to register, manage, and reference the node template 338 and the node instance 340, respectively, within the overlay system 202. The version ID 342b of the node template 338 is incremented when the node template 338 undergoes a transactional change. Similarly, the version ID 376 of the node instance 340 is incremented when the node instance 340 undergoes a transactional change. The namespace 342c of the node template 338, along with the name 342d of the node template 338, is used to help organize node templates within the executable graph-based model 100. That is, the node template 338 is assigned a unique name 342d within the namespace 342c such that the name 342d of the node template 338 need not be unique within the entire executable graph-based model 100, only within the context of the namespace 342c to which the node template 338 is assigned. The node template 338 optionally comprises one or more icons 342e which are used to provide a visual representation of the node template 338. The one or more icons 342e can include icons at different resolutions and display contexts such that the visualization of the node is adapted to different display contexts and settings. The node template 338 also optionally comprises the set of labels 342f which are used to override the name 342d when the node template 338 is rendered or visualized.

The node template 338 supports the software development feature of multiple inheritance by maintaining references (not shown) to zero or more other node templates, which then act as the base of the node template 338. This allows the behavior and functionality of a node template to be extended or derived from one or more other node templates within an executable graph-based model (such as the executable graph-based model 100). The node instance 340 likewise supports multiple inheritance because it is an instance representation of the node template 338. The multiple inheritance structure of the node instance 340 is, however, limited to the corresponding instance realization of the multiple inheritance structure defined by the node template 338, i.e., one node instance 340 is created and managed for each node template 338 defined in the inheritance hierarchy for a node instance of a node template.

The inheritance IDs 346 of the node template 338 provide an indication of the inheritance-based information, which is applicable, or can be applicable, to the node template 338. The inheritance IDs 346 have a description that is similar to the inheritance IDs 306. The abstract flag 354 has a description that is similar to the abstract flag 316, the leaf flag 356 has a description that is similar to the leaf flag 318, and the root flag 358 has a description that is similar to the root flag 320.

In embodiments, when an active node may be a run-time node, all elements within the executable graph-based model 100 are defined as combinations of node templates and node instances. The functionality of the node template 338 and the node instance 340 are realized due to the use of the node-type template 344 and the node-type instance 378. The node-type template 344 of the node template 338 is used to extend the functionality of the node template 338 by defining the standard set of capabilities, including data and associated behavior.

The vertex node-type template 366 (also referred to as a data node-type) includes a template of common data structures and functionality related to the ‘things’ modeled in the graph (e.g., the data). The vertex node-type instance 386 includes the common data structures and functionality related to the ‘things’ modeled in the graph based on the vertex node-type template 366. The edge node-type template 368 includes a template of common data structures and functionality related to joining two or more nodes. A node instance having the edge node-type instance 388 may connect two or more nodes and thus the edge node-type instance 388 constructs associations and connections between nodes (for example, objects or ‘things’) within the executable graph-based model 100. The edge node-type instance 388 is not restricted to the number of nodes that can be associated or connected by a node having the edge node-type instance 388. The data structures and functionality of the edge node-type instance 388 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The role node-type template 372 is used to define structure, conditions, or the like for establishing a connective relationship between two node instances or node templates. Similarly, the role node-type instance 392 is used to define a connective relationship between two node instances. The overlay node-type template 370 is used to extend the functionality of a node template (e.g., the node template 338) to incorporate processing logic. Similarly, the overlay node-type instance 390 is used to extend the functionality of a node instance (e.g., the node instance 340) to incorporate processing logic.

The set of attribute templates 348 corresponds to the data defined by the node template 338. For example, the set of attribute templates 348 may define the names and value types (e.g., integer, string, float, etc.) of one or more attributes but not the values of these attributes. The values of the set of attribute templates 348 may be defined by the set of attribute instances 380 of the node instance 340 through one or more values or instance values. For example, the node template 338 may define a string attribute ‘surname’ and the corresponding node instance 340 may assign the instance value ‘Bell-Richards’ to this string attribute. Each attribute instance of the set of attribute instances 380 is associated with an attribute template of the set of attribute templates 348. The node template 338 may define one or more default values for the set of attribute templates 348. The default values correspond to the values that the attributes take if no value is assigned. The metadata 350 (e.g., data stored as a name, a value type, and a value triplet) is associated with either the node template 338 or one or more of the set of attribute templates 348 of the node template 338. Similarly, the node instance 340 also optionally comprises the metadata 350 (e.g., data stored as a name, a value type, and a value triplet) which is associated with either the node instance 340 or one or more of the set of attribute instances 380.

The node configuration 352 provides a high degree of configurability for the different elements of a node template and/or a node instance. An example of a concrete node configuration strategy is an ID strategy, associated with the configuration of the unique ID 342a of the node template 338. A further example of a concrete node configuration strategy is a versioning strategy, associated with the configuration of the version ID 342b of the node template 338 which supports major and minor versioning (depending on the type of transactional change incurred). The versioning strategy may be adapted to a native filing system of a user device hosting the overlay system 202 or a third-party data storage (for example, Snowflake^{®}, or the like) associated with the overlay system 202.

An active node (for example, the generic node 302, the run-time node 336) with an overlay node-type is an overlay node. The overlay node may be the standard operations overlay node or the telemetry operations overlay node. The standard operations overlay node may include processing logic that when executed may perform one or more non-telemetry operations associated with the overlay system 202. The telemetry operations overlay node may include processing logic that when executed may perform one or more operations for analyzing one or more telemetry datasets. Such an analysis of the telemetry datasets corresponds to a telemetry operation.

It will be apparent to a person skilled in the art that each node of the executable graph-based model 100 has a standard structure that is similar to the standard structure of the generic node 302 of FIG. 3A or the run-time node 336 of FIG. 3B.

FIG. 4A is a block diagram 400A that illustrates a standard structure of a generic telemetry node 402 within the executable graph-based model 100, consistent with disclosed embodiments of the present disclosure. Referring to FIG. 4A, the generic telemetry node 402 corresponds to the core structure of the executable graph-based model 100 and forms the foundational building block for various data and processing logics within the executable graph-based model 100. The generic telemetry node 402 includes properties 404, inheritance IDs 406, a node-type 408, attributes 410, metadata 412, and a node configuration 414. The generic telemetry node 402 may be associated with one or more generic nodes (for example, the generic node 302). The generic telemetry node 402 may be a master telemetry node or a slave telemetry node. In some embodiments, when the generic telemetry node 402 may be the master telemetry node, the generic node 302 may be a composite node that may be a combination of two or more generic nodes. In such embodiments, the slave telemetry node created by the master telemetry node may also be the composite node.

The properties 404 include a unique ID 404a, a version ID 404b, a namespace 404c, a name 404d, one or more icons 404e, one or more labels 404f, and one or more alternative IDs 404g. The properties 404 of the generic telemetry node 402 have a description similar to the description of the properties 304 of the generic node 302. In other words, the unique ID 404a, the version ID 404b, the namespace 404c, the name 404d, the one or more icons 404e, the one or more labels 404f, and the one or more alternative IDs 404g have descriptions similar to the description of the unique ID 304a, the version ID 304b, the namespace 304c, the name 304d, the one or more icons 304e, the one or more labels 304f, and the one or more alternative IDs 304g, respectively, of the generic node 302.

The inheritance IDs 406 of the generic telemetry node 402 include an abstract flag 416, a leaf flag 418, and a root flag 420. The inheritance IDs 406 of the generic telemetry node 402 has a description similar to the description of the inheritance IDs 306 of the generic node 302. In other words, the abstract flag 416, the leaf flag 418, and the root flag 420 have descriptions similar to the description of the abstract flag 316, the leaf flag 318, and the root flag 320, respectively, of the generic node 302.

The attributes 410 of the generic telemetry node 402 have a description similar to the description of the attributes 310 of the generic node 302. In addition, the metadata 412 has a description similar to the description of the metadata 312 of the generic node 302.

The node configuration 414 of the generic telemetry node 402 includes node configuration strategies 422 and node configuration extensions 424. The node configuration 414 is same as the node configuration 314 of the generic node 302. In other words, the node configuration strategies 422 and the node configuration extensions 424 of the generic telemetry node 402 are the same as the node configuration strategies 322 and the node configuration extensions 324, respectively, of the generic node 302.

The generic telemetry node 402 may be the master telemetry node or the slave telemetry node. In some embodiments, when the generic telemetry node 402 may be the master telemetry node, the generic telemetry node 402, may retrieve a telemetry dataset from the generic node 302. Subsequently, the generic telemetry node 402 may generate a slave telemetry node that may represent the retrieved telemetry dataset. The generic telemetry node 402, which may be the master telemetry node, may have a node-type 408. The node-type 408 of the master telemetry node may be a combination of an edge node-type 430 and an overlay node-type 432 included in predetermined node-types 426 of the generic telemetry node 402. The edge node-type 430 may have a description that may be same as the description of the edge node-type 330. The overlay node-type 432 may have a description that may be same as the description of the overlay node-type 332. Therefore, the generic telemetry node 402 may exhibit the capabilities of an edge node and an overlay node.

In some embodiments, when the generic telemetry node 402 may be a slave telemetry node, the generic telemetry node 402 may be generated by a master telemetry node. The generic telemetry node 402 may represent a telemetry dataset acquired by the master telemetry node. Based on the generic telemetry node 402 being the slave telemetry node, the node-type 408 may be one of the predetermined node-types 426. The predetermined node-types 426 may include a vertex node-type 428, the edge node-type 430, the overlay node-type 432, and a role node-type 434 that may have descriptions similar to the descriptions of the vertex node-type 328, the edge node-type 330, the overlay node-type 332, and the role node-type 334, respectively. The generic telemetry node 402 with the vertex node-type 428 is a vertex telemetry node, the generic telemetry node 402 with the edge node-type 430 is an edge telemetry node, the generic telemetry node 402 with the overlay node-type 432 is an overlay telemetry node, and the generic telemetry node 402 with the role node-type 434 is a role telemetry node. The node-type 408 is one of the vertex node-type 428, the edge node-type 430, the overlay node-type 432, and the role node-type 434 based on one of (i) node-type of an active node from which the telemetry dataset, being represented by the generic telemetry node 402, is retrieved or (ii) type of data included in the telemetry dataset. Hereinafter, an active node, telemetry dataset retrieved from which is being represented by a slave telemetry node (e.g., generic telemetry node 402), is referred to as a source active node for the slave telemetry node.

In an instance, when a node-type of the source active node (e.g., the generic node 302) is the vertex node-type (for example, the vertex node-type 328), the node-type of the slave telemetry node (e.g., generic telemetry node 402) corresponds to the vertex node-type 428. That is to say that, based on the source active node being the vertex node, the slave telemetry node is the vertex telemetry node.

In an instance, when a node-type of the source active node is the edge node-type (for example, the edge node-type 330), the node-type of the slave telemetry node corresponds to the edge node-type 430. That is to say that, based on the source active node being the edge node, the slave telemetry is the edge telemetry node.

In an instance, when a node-type of the source active node is the overlay node-type (for example, the overlay node-type 332), the node-type of the slave telemetry node corresponds to the overlay node-type 432. That is to say that, based on the source active node being the overlay node, the slave telemetry node is the overlay telemetry node.

In an instance, when a node-type of the source active node is the role node-type (for example, the role node-type 334), the node-type of the slave telemetry node corresponds to the role node-type 434. That is to say that, based on the source active node being the role node, the slave telemetry node is the role telemetry node.

In an instance, when the telemetry dataset is indicative of an entity (namely, data), the slave telemetry node has the vertex node-type 428. In another instance, when the telemetry dataset is indicative of an association between two or more entities, the slave telemetry node has the edge node-type 430. In another instance, when the telemetry dataset is indicative of a capacity in which two or more entities are associated, the slave telemetry node has the role node-type 434. In another instance, when the telemetry dataset is indicative of processing logic, the slave telemetry node has the overlay node-type 432.

In some embodiments, when the generic telemetry node 402 may be the slave telemetry node, the generic telemetry node includes a telemetry dataset 435 that is configured to store the telemetry dataset retrieved from the source active node. The generic telemetry node 402 may represent the source active node based on the telemetry dataset included in the telemetry dataset 435.

FIG. 4B is a block diagram 400B that illustrates a standard structure of a run-time telemetry node 436 within the executable graph-based model 100, consistent with disclosed embodiments of the present disclosure. Referring to FIG. 4B, the run-time telemetry node 436 corresponds to the core structure of the executable graph-based model 100 and forms the foundational building block for all data and processing logic within the executable graph-based model 100.

The run-time telemetry node 436 is shown to include a node template 438 and a node instance 440. The node template 438 may correspond to a telemetry node template and the node instance 440 may correspond to a telemetry node instance. The node instance 440 is generated according to the node template 438. The node template 438 forms a data structure for the node instance 440. Notably, the node template 438 corresponds to a predefined telemetry node structure. The node instance 440 may be an implementation of the node template 438. The node instance 440 may include a reference (for example, a point, a storage location, or the like) associated with the node template 438.

The run-time telemetry node 436 shown in FIG. 4B is a compositional structure that is generated and executed, at run-time as part of the executable graph-based model 100. In other words, the node template 438 is defined as ‘offline’ and the node instance 440 and the run-time telemetry node 436 may be run-time structures that may be dynamically generated during execution of the executable graph-based model 100.

The node template 438 has a description similar to the description of the node template 338 described in conjunction with FIG. 3B whereas the node instance 440 has a description similar to the description of the node instance 340 described in conjunction with FIG. 3B.

The node template 438 may include properties 442, a node-type template 444, inheritance IDs 446, and a set of attribute templates 448. The node template 438 may optionally include metadata 450 and node configuration 452. The properties 442 of the node template 438 include a unique identifier (ID) 442a, a version ID 442b, a namespace 442c, a name 442d, and optionally include one or more icons 442e and a set of labels 442f. The inheritance IDs 446 comprise an abstract flag 454, a leaf flag 456, and a root flag 458. The node configuration 452 optionally comprises one or more node configuration strategies 460 and/or one or more node configuration extensions 462. FIG. 4B further shows a plurality of predetermined node-type templates 464. The plurality of predetermined node-type templates 464 may include a vertex node-type template 465, an edge node-type template 466, an overlay node-type template 467, and a role node-type template 468 having descriptions that may be same as the descriptions of the vertex node-type template 366, the edge node-type template 368, the overlay node-type template 370, and the role node-type template 372, respectively.

The node instance 440 may include a unique ID 469, a version ID 470, node-type instance 471, and a set of attribute instances 472. The node instance 440 may optionally include metadata 473. FIG. 4B further shows a plurality of predetermined node-type instances 474. The plurality of predetermined node-type instances 474 include a vertex node-type instance 475, an edge node-type instance 476, an overlay node-type instance 477, and a role node-type instance 478.

The properties 442 of the node template 438 may have a description that is similar to the description of the properties 342 described in conjunction with FIG. 3B. In other words, the unique ID 442a, the version ID 442b, the namespace 442c, the name 442d, the icons 442e, and the set of labels 442f may have descriptions that may be similar to descriptions of the unique ID 342a, the version ID 342b, the namespace 342c, the name 342d, the icons 342e, and the set of labels 342f, respectively, shown in FIG. 3B.

The inheritance IDs 446 of the node template 438 has a description that is similar to the inheritance IDs 346 of the node template 338. In other words, the abstract flag 454, the leaf flag 456, and the root flag 458 may have descriptions that may be similar to the abstract flag 354, the leaf flag 356, and the root flag 358, respectively, shown in FIG. 3B.

In some embodiments, the functionality of the node template 438 and the node instance 440 may be realized due to the use of the node-type template 444 and the node-type instance 471, respectively. The node-type template 444 has a description that is similar to the node-type template 344 of the node template 338 shown in FIG. 3B. The predetermined node-type templates 464 is same as the predetermined node-type templates 364. In other words, the vertex node-type template 465, the edge node-type template 466, the overlay node-type template 467, and the role node-type template 468 may have descriptions that may be similar to the descriptions of the vertex node-type template 366, the edge node-type template 368, the overlay node-type template 370, and the role node-type template 372, respectively, shown in FIG. 3B. The set of attribute templates 448 has a description that is similar to the description of the set of attribute templates 348 described in conjunction with FIG. 3B. The metadata 450 has a description that is similar to the metadata 350 depicted in FIG. 3B.

The node configuration 452 has a description that may be similar to the node configuration 352 of FIG. 3B. In other words, the description of the node configuration strategies 460 may be similar to the description of the node configuration strategies 360, and the description of the node configuration extensions 462 is similar to the description of the node configuration extensions 362.

The unique ID 469 may have a description similar to the unique ID 374 described in conjunction with FIG. 3B. The version ID 470 may have a description similar to the version ID 376 described in conjunction with FIG. 3B. The node-type instance 471 has a description that is similar to the node-type instance 378 of the node instance 340 shown in FIG. 3B. The predetermined node-type instances 474 may have a description that may be same as the description of the predetermined node-type instances 384. In other words, the vertex node-type instance 475, the edge node-type instance 476, the overlay node-type instance 477, and the role node-type instance 478 may have descriptions that may be similar to the descriptions of the vertex node-type instance 386, the edge node-type instance 388, the overlay node-type instance 390, and the role node-type instance 392 shown in FIG. 3B.

The set of attribute instances 472 has a description that is similar to the set of attribute instances 380 of FIG. 3B and the metadata 473 have a description that is similar to the metadata 382 of FIG. 3B.

Similarly, the edge node-type instance 476 has a description similar to the description of the edge node-type instance 388 shown in FIG. 3B whereas the overlay node-type instance 477 has a description similar to the description of the overlay node-type instance 390 shown in FIG. 3B.

The run-time telemetry node 436 may be the master telemetry node or the slave telemetry node. When the run-time telemetry node 436 may be the master telemetry node, the node-type template 444 may be a combination of the edge node-type template 466 and the overlay node-type template 467. In addition, the node-type instance 471 may be a combination of the edge node-type instance 476 and the overlay node-type instance 477.

When the run-time telemetry node 436 may be the slave telemetry node, the node-type template 444 may be one of the vertex node-type template 465, the edge node-type template 466, the overlay node-type template 467, and the role node-type template 468. In addition, the node-type instance 471 is one of the vertex node-type instance 475, the edge node-type instance 476, the overlay node-type instance 477, and the role node-type instance 478.

Description of a node-type of the run-time telemetry node 436, which is a combination of the node-type template 444 and the node-type instance 471, is same as the description of the node-type of the generic telemetry node 402 described in conjunction with FIG. 4A.

Throughout the description, a node (for example, an active node, a telemetry node, or the like) when associated with an overlay node is referred to as an executable node and may exhibit data as well as processing capability at run-time.

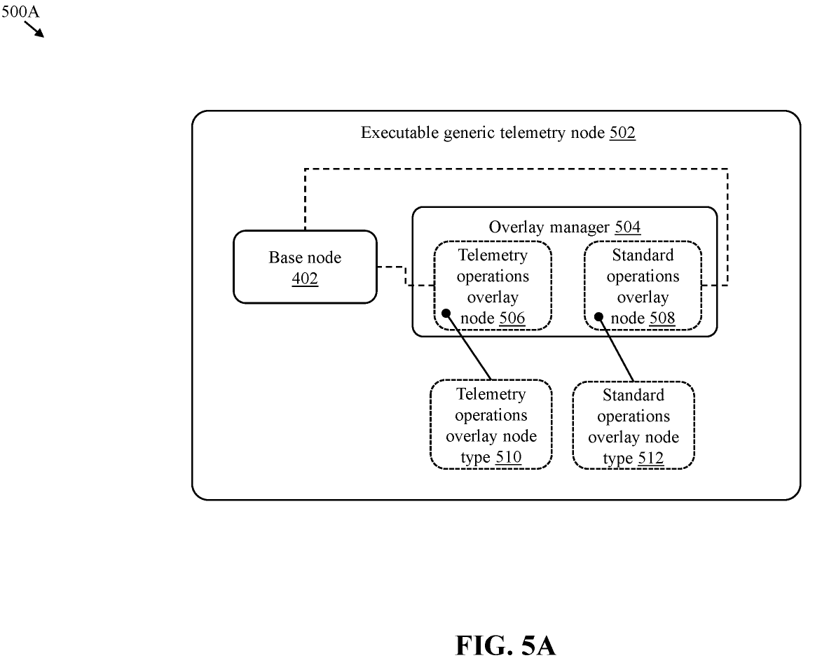

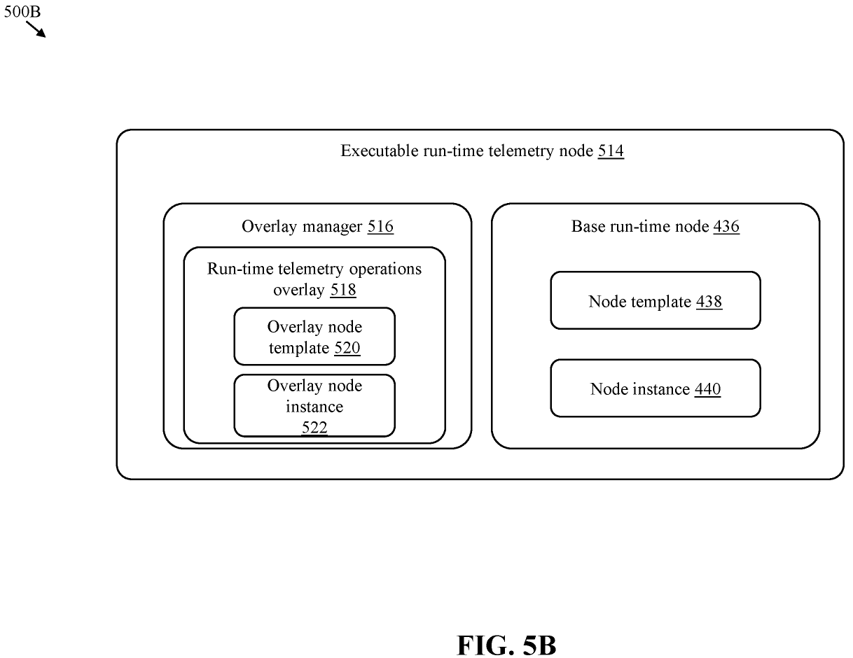

FIG. 5A is a block diagram 500A that illustrates an executable generic telemetry node 502 within the executable graph-based model 100, consistent with disclosed embodiments of the present disclosure. Referring to FIG. 5A, the executable generic telemetry node 502 is shown to include a base node (e.g., the generic telemetry node 402) and an overlay manager 504. For the sake of ongoing discussion, the base node corresponds to the generic telemetry node 402, and is hereinafter referred to as the “base node 402”. The base node 402 when extended by way of one or more overlay nodes becomes the executable generic telemetry node 502. The executable generic telemetry node 502 may have a telemetry operations overlay node 506 and a standard operations overlay node 508 associated therewith.

The overlay manager 504 registers and maintains one or more overlay nodes (such as the telemetry operations overlay node 506 and the standard operations overlay node 508) associated with the base node 302. The assignment of the telemetry operations overlay node 506 and the standard operations overlay node 508 associated with the base node 402 (via the overlay manager 504) endows the base node 402 with processing logic and executable functionality defined within the telemetry operations overlay node 506 and the standard operations overlay node 508 associated with the base node 302.

The executable generic telemetry node 502 provides processing functionality (e.g., processing logic) to the base node 402 via one or more associated overlay nodes (for example, the telemetry operations overlay node 506 and the standard operations overlay node 508). Beneficially, the data and processing capability of the base node 402 may be dynamically and significantly extended using the concept of an executable node (for example, the executable generic telemetry node 502). As shown, the telemetry operations overlay node 506 has a telemetry operations overlay node-type 510 and the standard operations overlay node 508 has a standard operations overlay node-type 512. Therefore, the telemetry operations overlay node 506 is associated with the telemetry operations overlay node-type 510 and the standard operations overlay node 508 is associated with the standard operations overlay node-type 512. Examples of telemetry operations overlay node-type include, but are not limited to an analysis overlay node-type, an alert overlay node-type, a monitoring overlay node-type, an audit overlay node-type, and a reporting overlay node-type.

An active node with the analysis overlay node-type is a telemetry operations overlay node (for example, an analysis overlay node) that includes processing logic for performing analysis of operational data (for example, wait time, processing time, latency, throughput, loading time, unloading time, creation time, or the like) of an associated telemetry node. An active node with the alert overlay node-type is another telemetry operations overlay node (for example, an alert overlay node) that includes processing logic that when executed on an associated telemetry node may generate an alert based on detection of an anomaly associated with the performance of the overlay system 202. An active node with the reporting overlay node-type is a telemetry operations overlay node that includes processing logic that when executed may generate one or more reports indicative of overall performance of the overlay system 202.

Examples of standard operations overlay node-type include, but are not limited to, a subscriber overlay node-type, a publisher overlay node-type, and an encryption overlay node-type. A node with the subscriber overlay node-type is a subscriber overlay node that is indicative of an operation of receiving an input from an associated node. The subscriber overlay node also includes processing logic to receive the input. A node with the publisher overlay node-type is a publisher overlay node that is indicative of an operation of publishing an output of an associated node. The publisher overlay node also includes processing logic to publish the output. A node with the encryption overlay node-type is an encryption overlay node that is indicative of an encryption technique using which an associated node is to be secured. The encryption overlay node also includes processing logic to secure a corresponding node. Examples of the encryption technique include a symmetric encryption algorithm, an asymmetric encryption algorithm, a combination of these, or any other encryption technique.

Although, the executable generic telemetry node 502 is shown to be associated with the telemetry operations overlay node 506 and the standard operations overlay node 508, in other embodiments, the executable generic telemetry node 502 may include any number of overlay nodes (for example, the telemetry operations overlay nodes and the standard operations overlay nodes) without deviating from the scope of the present disclosure.

The executable generic telemetry node 502 extends the base node 402 (or is a subtype of the base node 402) such that all the functionality and properties of the base node 402 are accessible to the executable generic telemetry node 502. The executable generic telemetry node 502 also dynamically extends the functionality of the base node 402 by associating the overlay nodes maintained by the overlay manager 504 with the base node 402. The executable generic telemetry node 502 may thus be considered a combination of the base node 402 and the telemetry operations overlay node 506 and standard operations overlay node 508. The executable generic telemetry node 502 may be alternatively referred to as a node with overlay(s). Therefore, the executable generic telemetry node 502 acts as a decorator of the base node 402 adding the functionality of the overlay manager 504 to the base node 402.

It will be apparent to a person skilled in the art that the base node 402 refers to a dedicated node within the executable graph-based model 100. As such, the base node 402 may correspond to a master telemetry node or a slave telemetry node.

Alternatively, the base node 402 may be an executable node such that the functionality of the (executable) base node 402 is dynamically extended. In this way, complex and powerful processing functionality can be dynamically generated by associating and extending overlay nodes.

Extending the functionality of a base node through one or more overlay nodes is at the heart of the overlay system 202. As illustrated in FIG. 2, the data (e.g., a vertex node as represented by the base node 402 in FIG. 5A) and the functionality that acts upon that data (e.g., an overlay node) can be separated and independently maintained offline, but at run-time, an association between the data node and the overlay node is determined and an executable node is generated (e.g., the executable generic telemetry node 502 shown in FIG. 5A).

It will be apparent to a person skilled in the art that functionalities of the telemetry operations overlay node 506 and the standard operations overlay nodes 508 may be performed by a single overlay node that includes processing logic associated with both the telemetry operations overlay node and the standard operations overlay nodes.

It will be apparent to a person skilled in the art that the list of overlay node-types is not exhaustive and the number of different overlay node-types that can be realized is not limited. Because an overlay node is itself a node, all functionality of a node described in relation to the base node 402 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

An overlay node, such as the telemetry operations overlay node 506 or the standard operations overlay node 508, is not bound to a single executable node or a single executable graph-based model (unlike nodes that have non-overlay node-types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 504 of the executable generic telemetry node 502 is responsible for executing all overlays registered therewith. The overlay manager 504 also coordinates the execution of all associated overlay nodes. As shown in FIG. 5A, the executable generic telemetry node 502 associates the base node 402 with two overlay nodes that is the telemetry operations overlay node 506 and the standard operations overlay node 508. Thus, the overlay manager 504 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 504 and are associated with an overlay via a node configuration telemetry for the overlay.

It will be apparent to a person skilled in the art that association of a generic node with one or more overlay nodes may be facilitated within the overlay system 202 as described in conjunction with the executable generic telemetry node 502.

FIG. 5B is a block diagram 500B that illustrates an executable run-time telemetry node 514 within the executable graph-based model 100, consistent with disclosed embodiments of the present disclosure. Referring to FIG. 5B, the executable run-time telemetry node 514 is shown to include the run-time telemetry node 436 (hereinafter referred to as ‘the base run-time node 436’) and an overlay manager 516. The base run-time node 436 may be associated with a run-time telemetry operations overlay node 518. Hence, the overlay manager 516 may include the run-time telemetry operations overlay node 518. The executable run-time telemetry node 514 provides processing functionality (e.g., processing logic) to the base run-time node 436 via one or more associated overlay nodes (for example, the run-time telemetry operations overlay node 518). Beneficially, the data and processing capability of the base run-time node 436 may be dynamically and significantly extended using the concept of an executable run-time node (for example, the executable run-time telemetry node 514).

Although the executable run-time telemetry node 514 is shown to include a single run-time telemetry operations overlay node 518, in other embodiments, the executable run-time telemetry node 514 may include any number of run-time overlay nodes. The run-time telemetry operations overlay node 518 may include an overlay node template 520 and an overlay node instance 522. The overlay node template 520 and an overlay node instance 522 may, collectively, constitute the run-time telemetry operations overlay node 518.

Although the executable run-time telemetry node 514 is shown to include the run-time telemetry operations overlay node 518, in other embodiments, the executable run-time telemetry node 514 may include a run-time standard operations overlay node.

The executable run-time telemetry node 514 extends the base run-time node 436 (or is a subtype of the base run-time node 436) such that all the functionalities and properties of the base run-time node 436 may be accessible to the executable run-time telemetry node 514. The executable run-time telemetry node 514 also dynamically extends the functionality of the base run-time node 436 by associating the run-time overlay nodes maintained by the overlay manager 516 with the base run-time node 436. The executable run-time telemetry node 514 may thus be considered a composition of the base run-time node 436 and the run-time telemetry operations overlay node 518. The executable run-time telemetry node 514 may be alternatively referred to as a run-time node with overlay(s). Therefore, the executable run-time telemetry node 514 acts as a decorator of the base run-time node 436 adding the functionality of the overlay manager 516 to the base run-time node 436.

It will be apparent to a person skilled in the art that the base run-time node 436 refers a dedicated node within the executable graph-based model 100. As such, the base run-time node 436 may correspond to a master telemetry node having a node-type that is a combination of an edge node-type and an overlay node-type. The base node 402 may correspond to a run-time slave telemetry node having vertex node-type, edge node-type, overlay node-type, or a role node-type based on the type of the telemetry dataset of an active node represented thereby.

Alternatively, the base run-time node 436 may itself be an executable node such that the functionality of the (executable) base run-time node 436 is dynamically extended. In this way, complex and powerful processing functionality can be dynamically generated by associating and extending overlay nodes.

The overlay manager 516 registers and maintains one or more run-time overlay nodes (such as the run-time telemetry operations overlay node 518) associated with the base run-time node 436. The assignment of the run-time telemetry operations overlay node 518 to the base run-time node 436 (via the overlay manager 516) endows the base run-time node 436 with processing logic and executable functionality defined within the run-time telemetry operations overlay node 518. In other words, the run-time telemetry operations overlay node 518 may interact at run-time, with the node template 438 and/or the node instance 440 of the base run-time node 436. In an example, the node template 438 and the node instance 440 may be not executable nodes. That is, neither the node template 438 nor the node instance 440 comprises an overlay manager with one or more run-time overlay nodes. In another example, the node template 438 and/or the node instance 440 may be executable nodes, thereby extending the functionality, complexity, and configurability of executable run-time nodes.

Extending the functionality of a base run-time node through one or more run-time overlay nodes is at the heart of the overlay system 202. As illustrated in FIG. 2, the data (e.g., a vertex node as represented by the base run-time node 436 in FIG. 4B) and the functionality that acts upon that data (e.g., an overlay node) can be separated and independently maintained offline, but at run-time, an association between the data node and the run-time overlay node is determined and an executable run-time node is generated (e.g., the executable run-time telemetry node 514).

Each run-time overlay node comprises an overlay node template and an overlay node instance. The overlay node template is a node template with the overlay node-type template. Similarly, the overlay node instance is a node instance with the overlay node-type instance. The overlay node instance is an implementation of the overlay node template. The overlay node template comprises one or more generic rules that may be implemented by the processing logic of the overlay node instance. For example, a rule may be defined in an overlay node template specifying that hashing algorithm is to be used and an overlay instance associated with the overlay template provides a specific implementation of a hashing algorithm (e.g., Message-Digest Algorithm 5 (MD5), Secure Hash Algorithm-1 (SHA-1), SHA-2, etc.).

A run-time overlay node, such as the run-time telemetry operations overlay node 518, is a node having an overlay node-type (alternatively referred to as an overlay type) assigned to its node-type. Examples of telemetry operations overlay node-types include an alert overlay node-type, a notification overlay node-type, an audit overlay node-type, an analytics overlay node-type, a notification overlay node-type, a reporting overlay node-type, a contract overlay node-type, a compliance overlay node-type or the like. It will be apparent to a person skilled in the art that the list of overlay node-types is not exhaustive and the number of different overlay node-types that can be realized is not limited.

Because an overlay node is itself a node, all functionality of a node described in relation to the base run-time node 436 is thus applicable to an overlay node. For example, an overlay node may include a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

A run-time overlay node, such as the run-time telemetry operations overlay node 518, is not bound to a single executable node or a single executable graph-based model (unlike nodes that have non-overlay node-types). This allows run-time overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays.

Unlike non-run-time overlay nodes, a run-time overlay node may include processing logic (not shown in FIG. 5B) which determines the functionality of the run-time overlay node. The processing logic of a run-time overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 516 of the executable run-time telemetry node 514 is responsible for executing all overlays registered therewith. The overlay manager 516 also coordinates the execution of all associated overlay nodes. As shown in FIG. 5B, the executable run-time telemetry node 514 associates the base run-time node 436 with the run-time telemetry operations overlay node 518.

In some embodiments, the overlay manager 516 employs a strategy to manage potentially cascading execution flow of overlays such that one overlay may be associated with one or more other overlays. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies may be defined and registered with the overlay manager 516 and may be associated with an overlay via a node configuration telemetry for the overlay.

It will be apparent to a person skilled in the art that association of a run-time node with one or more run-time overlay nodes may be facilitated within the overlay system 202 as described in conjunction with the executable run-time telemetry node 514.

FIG. 6 is a block diagram 600 that illustrates a composition of the executable generic telemetry node 502 that enables persistent storage of data and the processing logic associated therewith, consistent with disclosed embodiments of the present disclosure.

As described in conjunction with FIG. 5A, the executable generic telemetry node 502 includes the base node 402 and one or more overlay nodes (e.g., the telemetry operations overlay node 506 and the standard operations overlay node 508). For the sake of brevity of the ongoing description, the persistent storage is explained for the executable generic telemetry node 502 including only the telemetry operations overlay node 506. One or more operations performed for ensuring the persistence of the telemetry operations overlay node 506 may be performed for the standard operations overlay node 508 as well.

Referring to FIG. 6, the executable generic telemetry node 502 includes the base node 402 and the telemetry operations overlay node 506. The executable generic telemetry node 502 has a corresponding first state 602 having a first ID 604. The base node 402 has a second state 606 having a second ID 608, and the telemetry operations overlay node 506 has a third state 610 having a third ID 612. A manifest (for example, first through third manifests 614-618) is generated for each of the executable generic telemetry node 502, the base node 402, and the telemetry operations overlay node 506. In an embodiment, the manifests may be generated by the storage management module 220. The first manifest 614 is associated with the executable generic telemetry node 502 and has a fourth ID 620 and an overlay ID 622. The second manifest 616 is associated with the base node 402 and has a fifth ID 624. The third manifest 618 is associated with the telemetry operations overlay node 506 and has a sixth ID 626. Further, the manifests are stored at respective storage locations that may be centralized or distributed storage locations associated with the overlay system 202. The manifests may be stored by the storage management module 220.

The first state 602 of the executable generic telemetry node 502 includes data required to reconstruct the executable generic telemetry node 502 (e.g., attributes, properties, etc.). The first state 602 of the executable generic telemetry node 502 is persistently stored along with the first ID 604. The first manifest 614 is generated for the executable generic telemetry node 502 and has (i) the fourth ID 620 (which is the same as the first ID 604), (ii) the storage location of the first state 602 of the executable generic telemetry node 502, and (iii) the overlay ID 622 (which is the same as the sixth ID 626). Notably, the fourth ID 620 is the same as the first ID 604 and the fifth ID 624, hence, the first manifest 614 includes the ID of the state of the base node 402 and the executable generic telemetry node 502. Further, the overlay ID 622 is the same as the sixth ID 626 of the state of the telemetry operations overlay node 506. Therefore, the first manifest 614 may be used to identify and retrieve the states of the base node 402, the executable generic telemetry node 502, and the telemetry operations overlay node 506. Subsequently, the retrieved states may be used to reconstruct the executable generic telemetry node 502 and the telemetry operations overlay node 506. In an instance, the executable generic telemetry node 502 may be further extended to include additional overlay nodes. In such an instance, the first manifest 614 may include state IDs of the additional overlay nodes as well. A first manifest state (not shown) is then generated for the first manifest 614 and persistently stored along with the fourth ID 620.

The second state 606 of the base node 402 includes data required to reconstruct the base node 402 (e.g., attributes, properties, etc.) and is persistently stored along with the second ID 608. The second manifest 616 is generated for the base node 402 and has the fifth ID 624 and the storage location of the second state 606 of the base node 402. The second ID 608 of the second state 606 and the fifth ID 624 of the second manifest 616 are the same as the first ID 604 of the first state 602 of the executable generic telemetry node 502 (which is also the same as the fourth ID 620 of the first manifest 614 of the executable generic telemetry node 502). As mentioned above, along with the first state 602, the first manifest 614 may also be used to identify and retrieve the second manifest 616 which in turn may be used to identify the second state 606 of the base node 402. A second manifest state (not shown) is then generated for the second manifest 616 and persistently stored along with the fifth ID 624. Thus, the states, manifests, and manifest states for the executable generic telemetry node 502 and the base node 402 include the same, shared, ID. A shared ID can be used in this instance because the states, manifests, and manifest states are stored separately. The separate storage of the states, manifests, and manifest states exhibit a distributed architecture of the overlay system 202.

The third state 610 of the telemetry operations overlay node 506 includes data required to reconstruct the telemetry operations overlay node 506 (e.g., attributes, properties, processing logic, etc.) and is persistently stored along with the third ID 612. The third manifest 618 is generated for the telemetry operations overlay node 506 and includes the sixth ID 626, which is the same as the third ID 612. Therefore, the first manifest 614 may be further used to identify and retrieve the third manifest 618 which in turn may be used to identify and retrieve the third state 610 of the telemetry operations overlay node 506. A third manifest state (not shown) is then generated for the third manifest 618 and is persistently stored along with the sixth ID 626.

In operation, when the executable generic telemetry node 502 is to be loaded, the transaction module 208, in conjunction with the storage management module 220, may execute one or more operations to retrieve the first manifest state stored at a known storage location. Based on the first manifest state, the storage management module 220 may re-construct the first manifest 614 which includes the fourth ID 620 which is the same as the fifth ID 624 of the second manifest 616. Based on the fifth ID 624, the storage management module 220 may identify the second manifest state and may generate the second manifest 616 based on which the second state 606 is identified. Subsequently, the base node 402 is loaded and the storage management module 220 may determine that the base node is a node with overlay. Based on the fourth ID 620 (that is the same as the first ID 604 of the first state 602 of the executable generic telemetry node 502) of the first manifest 614, the first state 602 is identified and retrieved. Subsequently, the executable generic telemetry node 502 is loaded. Moreover, based on the overlay ID 622 (that is the same as the sixth ID 626 of the third manifest 618) of the first manifest 614, the third manifest state is identified and the third manifest 618 is generated. Subsequently, based on the sixth ID 626 (that is the same as the third ID of the third state) of the third manifest 618, the third state 610 is identified and retrieved. Based on the third state 610, the telemetry operations overlay node 506 is reconstructed and loaded in the executable graph-based model 100.

Based on a context of a stimulus (for example, the stimulus 230) associated with the overlay system 202, the processing logic (such as the context module 210) may determine an ID that is the same as the fifth ID 624. Based on the determined ID, the processing logic (such as the memory management module 218 and the storage management module 220) may identify the second manifest 616. Subsequently, the processing logic (such as the memory management module 218 and the storage management module 220) may identify the second state 606 that has the second ID 608 that matches the fifth ID 624. Further, the processing logic (such as the memory management module 218 and the storage management module 220) may retrieve the second state 606 associated with the second manifest 616 from a corresponding storage element. Subsequently, the processing logic (such as the memory management module 218 and the storage management module 220) may determine, by checking the manifest storage(s) associated with the overlay system 202, whether there is another manifest (such as the first manifest of the executable generic telemetry node 502) with an ID that matches the second ID 608 and the fifth ID 624. Notably, the first manifest 614 includes storage locations of each overlay node (for example, the telemetry operations overlay node 506) of the executable generic telemetry node 502. Based on the overlay ID 622 included in the first manifest 614 that matches the sixth ID 626 included in the third manifest 618, the processing logic (such as the memory management module 218 and the storage management module 220) may identify and retrieve the third manifest 618 from a manifest storage of a plurality of manifest storages of the overlay system 202. Subsequently, the processing logic (such as the memory management module 218 and the storage management module 220) may identify the third state 610 which has the third ID 612 that matches the sixth ID 626. Further, the processing logic (such as the memory management module 218 and the storage management module 220) may retrieve the third state 610 associated with the third manifest 618 from a corresponding storage element. To determine whether the telemetry operations overlay node 506 has an overlay node associated therewith, the processing logic (such as the memory management module 218 and the storage management module 220) may also perform a check to determine whether any of the plurality of manifest storages of the overlay system 202 includes any other manifest with an ID that matches the sixth ID 626. Since the telemetry operations overlay node 506 does not have an overlay associated therewith, no other manifest has the ID that matches the sixth ID.

Notably, the manifest (the third manifest 618) of the telemetry operations overlay node 506 includes a reference (such as an identifier that is common to the second manifest 616 and the third manifest 618, a link, a path, a storage location, or the like) to the second manifest 616 of the base node 402. Therefore, the re-formation of the executable generic telemetry node 502 includes a re-creation of the telemetry operations overlay node 506 prior to a re-creation of the base node 402. Subsequently, the telemetry operations overlay node 506 and the base node 402 are organized by associating the base node 402 with the telemetry operations overlay node 506 to re-form the executable generic telemetry node 502.

In some embodiments, the telemetry operations overlay node 506 may not be loaded in case it is not required for executing the operation associated with the stimulus 230. The loaded executable generic telemetry node 502 and the telemetry operations overlay node 506 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 6 illustrates only a single overlay node associated with the generic telemetry node, in other embodiments, the executable generic telemetry node 502 may include additional or different overlay nodes. It will also be apparent to a person skilled in the art that only those overlay nodes that are required for responding to the stimulus 230 may be loaded.

Notably, based on the generic node 302 being a non-templated node, the generic telemetry node 402 is a generic node which is a non-templated node. A non-templated node is a node that is not a run-time node and does not have a node template and a node instance. Additionally, based on the run-time node 336 being a run-time node, the run-time telemetry node is also a run-time node and includes the node template 438 and the node instance 440. Node template of a telemetry node corresponds to a telemetry node template and node instance of a telemetry node corresponds to a telemetry node instance.

It will be apparent to a person skilled in the art that the generic node 302 may be loaded in a manner similar to the loading of the base node 402. The generic node 302, when associated with an overlay node, may be loaded in a manner similar to the loading of the executable generic telemetry node 502. Additionally, the executable generic telemetry node 502 may include one or more identifiers of one or more associated telemetry nodes. Therefore, based on the loading of the executable generic telemetry node 502, the identifiers may be identified and the associated telemetry nodes may be loaded in a similar manner.

The executable run-time telemetry node 514 may be loaded by loading the node template 438 and the node instance 440. Each of the node template 438 and the node instance 440 may be loaded in a manner similar to the loading of the base node 402 as described in conjunction with FIG. 6. Additionally, the node instance 440 may include a reference to the node template 438. Therefore, the node template 438 may be identified based on the node instance 440 and may be loaded prior to the node instance 440. Also, each of the node template 438 and the node instance 440 may include a reference (for example, an identifier) to one or more node templates and one or more node instances, respectively, of one or more run-time nodes associated with the executable run-time telemetry node 514 as source nodes thereof. Therefore, based on the loading of the node template 438, the associated node templates may be loaded. Similarly, based on the loading of the node instance 440, the associated node instances may be loaded. In some embodiments, the node template 438 and the node instance 440 may be associated with node templates and node instances, respectively, of one or more run-time overlay nodes. In such embodiments, based on loading each of the node template 438 and the node instance 440, node templates and node instances of the one or more run-time overlay nodes may be loaded in a manner as described in conjunction with FIG. 6.

In some embodiments, the run-time node 336 may be loaded by loading the node template 338 and the node instance 340. Each of the node template 338 and the node instance 340 of the run-time node 336 may be loaded in a manner similar to the loading of the base node 402. Additionally, in an instance when the run-time node 336 may be extended by way of a run-time overlay node, the node template 338 and the node instance 340 may be associated with overlay node template and overlay node instance, respectively, of the run-time overlay node. In such a scenario, each of the node template 338 and the node instance 340 may be loaded in a manner similar to the loading of the executable generic telemetry node 502.

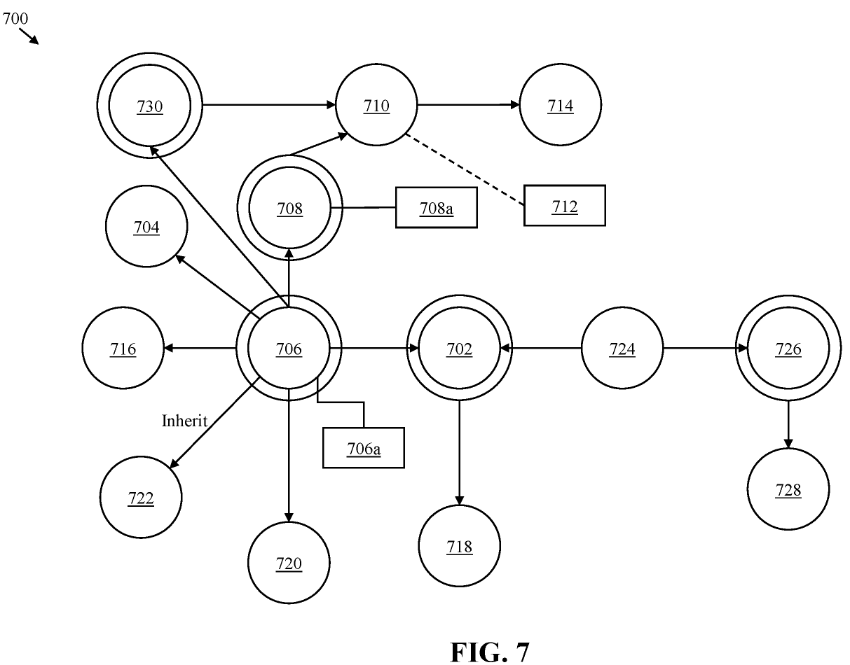

FIG. 7 illustrates a graph 700 that depicts implementation of the plurality of telemetry nodes in the executable graph-based model 100, consistent with disclosed embodiments of the present disclosure. Referring to FIG. 7, the graph 700 is shown to include a plurality of active nodes including active nodes 702 and 704. Each active node, of the plurality of active nodes, may have a vertex node-type (for example, the vertex node-type 328), an edge node-type (for example, the edge node-type 330), an overlay node-type (for example, the overlay node-type 332), or a role node-type (for example, the role node-type 334). An operation associated with the overlay system 202 may be executed based on the plurality of active nodes (for example, the active nodes 702 and 704) of the executable graph-based model 100.

Each active node may execute one or more operations of the overlay system 202. The execution of the one or more operations may be affected by an operational performance of the overlay system 202. The operational performance may correspond to effectiveness and efficiency with which various modules (shown in FIG. 2) of the overlay system 202 perform core operations (for example, node creation operations, node processing operations, communication operations among nodes, node loading operations, node unloading operations, or the like) associated therewith. The core operations of the overlay system 202 may be leveraged by a client system (for example, a recommendation system, a data organization system, or the like) that may have been implemented by way of the overlay system 202. Therefore, the operational performance of the overlay system 202 should be monitored continuously and in real-time to provide real-time insights for improving the operational performance of the overlay system 202. Such continuous and real-time monitoring is performed within the overlay system 202 by way of the implementation of a plurality of telemetry nodes in the executable graph-based model 100. The graph 700 is shown to include a plurality of master telemetry nodes.

As shown, the plurality of master telemetry nodes include a master telemetry node 706. The master telemetry node 706 is shown to be associated with the active node 702. The master telemetry node 706 may be configured to extract a telemetry dataset from a standard structure of the active node 702. The standard structure of the active node 702 may be same as the standard structure of the generic node 302 or the run-time node 336. The master telemetry node 706 may be configured to access and identify data, that is to be analyzed, from the standard structure of the active node. The identified data may be extracted and retrieved as the telemetry dataset associated with the active node 702. In an example, to determine a time period required for loading of a node, loading time is to be analyzed, therefore, the master telemetry node 706 may access the data in the standard structure of the active node 702 and may identify a loading time attribute to be included in the telemetry dataset. In another example, to determine a wait time associated with the active node 702, a created on and a processed on attribute may be identified and included in the telemetry dataset.

A standard structure of an active node may include various operational data including time and processing related data associated with the active node 702. The operational data may include, but are not limited to, a source node ID, a clone node ID, ID of correlated nodes, a created on timestamp, a raised on timestamp, a received on timestamp, a handled on timestamp, and a processed on timestamp.

The source node ID may refer to an ID of a source node that may have caused creation of the active node. The clone node ID may refer to an ID of a clone or duplicate node of the active node. The ID of correlated nodes may refer to IDs of one or more active nodes that may be related to the active node based on a transaction or creation thereof. The created on timestamp may include details (such as time, date, day, month, or the like) regarding the creation of the active node. The raised on timestamp may indicate a time instance when a request for an operation is generated. The received on timestamp may indicate a time instance when the active node has received the operation request. The handled on timestamp may indicate a time instance when processing of the received operation request, by the active node, is initiated. The processed on timestamp may indicate a time instance when execution of the operation, by the active node, is completed.

Notably, a gap between the handled on timestamp and the processed on timestamp may determine an actual computation time. A higher gap may indicate inefficient execution. Further, a delay between the created-on timestamp and the raised-on timestamp may indicate slow task generation due to system dependencies, and a delay between the raised-on timestamp and the received-on timestamp may indicate pipeline congestion. Moreover, a delay between the received-on timestamp and handled-on timestamp may indicate task scheduling inefficiencies or inefficient workload distribution. The telemetry dataset including such operational data may be used to generate telemetry insights that may be further utilized by the overlay system 202 to improve the operational performance thereof.

In operation, the processing circuitry (for example, the controller module 206, the transaction module 208, the stimuli management module 212, or the like) may receive a stimulus (for example, the stimulus 230) associated with the overlay system 202. The stimulus may be indicative of analysis of the operational performance of the overlay system 202 to generate a set of telemetry insights that may be used to optimize the operational performance of the overlay system 202. The stimulus may be indicative of a subject, domain, module, or facet of the overlay system 202 for which the operational performance of the overlay system 202 is to be analyzed. In an example, the stimulus may be indicative of the memory management module 218 and storage management module 220. Therefore, the operational performance of the overlay system 202 may be determined based on operational data (for example, loading time associated with one or more active nodes, unloading time associated with one or more active nodes) pertaining to the memory management module 218 and the storage management module 220. In another example, the stimulus may be indicative of a subject ‘Throughput’. Therefore, the operational performance of the overlay system 202 may be determined based on the operational data (for example, created on timestamps, raised on timestamps, handled on timestamps, processed on timestamps, or the like, associated with one or more active nodes) pertaining to various modules (shown in FIG. 2) performing one or more operations associated with the overlay system 202.

The processing circuitry (for example, the controller module 206, the transaction module 208, the stimuli management module 212, the active node management module 216, or the like) may be further configured to identify, based on the stimulus, the active node 702 of the plurality of active nodes. The active node 702 may be identified based on a context of the stimulus. In some embodiments, the context may be indicative of a unique ID of the active node 702. In some embodiments, the context may be indicative of an attribute (for example, loading time, event, or the like), label, icon, or any other component of the standard structure of the active node 702.

Upon the identification of the active node 702, the processing circuitry (for example, the controller module 206, the transaction module 208, or the like) may be configured to determine whether the active node 702 is unloaded from the executable graph-based model 100. Based on a determination that the active node 702 is unloaded from the executable graph-based model 100, the processing circuitry (for example, the controller module 206, the transaction module 208, the memory management module 218, the storage management module 220, or the like) may load the active node 702 in the executable graph-based model 100 as described in conjunction with FIG. 6.

The active node 702 may be associated with one or more master telemetry nodes. Each master telemetry node may be associated with a corresponding type of telemetry. Each master telemetry node may be designed to retrieve telemetry datasets, from associated active nodes, using which the corresponding type of telemetry may be performed. Each master telemetry node may be further associated with a corresponding set of telemetry parameters. The set of telemetry parameters associated with each master telemetry node may be indicative of attributes, configurations, or the like that may be retrieved from the associated active nodes to perform the corresponding type of telemetry. For example, a master telemetry node may have a corresponding type of telemetry ‘latency’. In such an example, the set of telemetry parameters may be indicative of a created on timestamp, a raised on timestamp, a handled on timestamp, a processed on timestamp, or the like as such telemetry parameters may be used to perform the type of telemetry ‘latency’.

From the one or more master telemetry nodes associated with the active node 702, the processing circuitry (for example, the controller module 206, the transaction module 208, the stimuli management module 212, the telemetry node management module 236, or the like) may determine the master telemetry node 706. The master telemetry node 706 may be determined based on the stimulus. The stimulus may be further indicative of a type of telemetry that may match a type of telemetry associated with the master telemetry node 706. Based on the type of telemetry indicated by the stimulus being a match to the type of telemetry associated with the master telemetry node 706, the processing circuitry (for example, the controller module 206, the transaction module 208, the stimuli management module 212, the telemetry node management module 236, or the like) may determine the master telemetry node 706. In some embodiments, the master telemetry node 706 may be determined based on association thereof with the active node 702.

Upon the determination of the master telemetry node 706, the processing circuitry (for example, the controller module 206, the transaction module 208, or the like) may be configured to determine whether the master telemetry node 706 is unloaded from the executable graph-based model 100. Based on a determination that the master telemetry node 706 is unloaded from the executable graph-based model 100, the processing circuitry (for example, the controller module 206, the transaction module 208, the memory management module 218, the storage management module 220, or the like) may load the master telemetry node 706 as described in conjunction with FIG. 6.

Subsequently, the processing circuitry (for example, the controller module 206, the transaction module 208, the stimuli management module 212, the telemetry node management module 236, or the like) may be configured to retrieve, based on the master telemetry node 706, a telemetry dataset from the active node 702. For retrieval of the telemetry dataset, the processing circuitry (for example, the controller module 206, the transaction module 208, the stimuli management module 212, the telemetry node management module 236, or the like) may analyze a standard structure of the active node 702. Based on the analysis, one or more elements (for example, attributes, ID, labels, icons, names, or the like) of the standard structure may be identified that may match the set of telemetry parameters associated with the master telemetry node 706. In some embodiments, the one or more elements may be identified based on requirement thereof to perform the type of telemetry associated with the master telemetry node 706. The identified elements of the standard structure of the active node 702 may form a telemetry dataset associated with the active node 702. The processing circuitry (for example, the controller module 206, the transaction module 208, the stimuli management module 212, the telemetry node management module 236, or the like) may retrieve the telemetry dataset from the active node 702. In an example, the type of telemetry associated with the master telemetry node 706 may be ‘Throughput’ and the set of telemetry parameters associated with the master telemetry node 706 may include processing time, creation time, handling time, completion time, or the like. Therefore, the processing circuitry (for example, the controller module 206, the transaction module 208, the stimuli management module 212, the telemetry node management module 236, or the like) may identify attributes created-on timestamp, raised-on timestamp, received-on timestamp, handled-on timestamp, processed-on timestamp, or the like from the standard structure of the active node 702. Therefore, the attributes created-on timestamp, raised-on timestamp, received-on timestamp, handled-on timestamp, processed-on timestamp, or the like and corresponding attribute values may form the telemetry dataset associated with the active node 702 and hence may be retrieved from the active node 702.

The processing circuitry (for example, the controller module 206, the transaction module 208, the stimuli management module 212, the telemetry node management module 236, or the like) may be further configured to use processing logic of the master telemetry node 706 to analyze the retrieved telemetry dataset to determine, a set of telemetry insights associated with the active node 702. The processing logic of the master telemetry node 706 may be used to analyze and correlate the one or more elements of the active node 702 included in the telemetry dataset to derive and determine the set of telemetry insights. In an embodiment, the telemetry dataset may be analyzed to detect one or more patterns associated with one or more operations of the overlay system 202. The set of telemetry insights may be determined based on the one or more patterns. In a first example, based on the analysis of the telemetry dataset, a pattern may be identified/detected which may be indicative of frequent loading and unloading of the active node 702. Therefore, the set of telemetry insights may be indicative of a frequent requirement of the active node 702 within the overlay system 202.

The set of telemetry insights may be indicative of one or more operational parameters associated with the overlay system 202. The operational parameters may correspond to one or more factors associated with operations of one or more modules of the overlay system 202 that may be affecting the operational performance of the overlay system 202. In a second example, the processing circuitry (for example, the controller module 206, the transaction module 208, the stimuli management module 212, the telemetry node management module 236, or the like) may analyze the telemetry dataset to determine that there are frequent long time intervals between the created-on timestamp and the processed-on timestamp of the active node 702. Therefore, the set of telemetry insights may be indicative of waiting time to get processed being long for the active node 702, resulting in a low corresponding throughput for the overlay system 202.

Subsequently, one or more corrective measures may be taken to optimize the operational performance of the overlay system 202. Referring back to the first example, a corrective measure may be taken to keep the active node 702 permanently loaded in the executable graph-based model 100. Hence, latency due to frequent loading and unloading of the active node 702 may be eliminated. Referring back to the second example, another corrective measure may be taken to prioritize processing of operations associated with the active node 702. It will be apparent to a person skilled in the art that an operation associated with the overlay system 202 is same as a transaction associated with the overlay system 202.

In some embodiments, for analyzing the retrieved telemetry dataset, the processing circuitry (for example, the controller module 206, the transaction module 208, the stimuli management module 212, the telemetry node management module 236, or the like) may be further configured to use the master telemetry node 706 to instantiate a slave telemetry node 708 in the executable graph-based model 100. The slave telemetry node 708 may represent the retrieved telemetry dataset as described in conjunction with FIGS. 4A and 4B. The processing circuitry (for example, the controller module 206, the transaction module 208, the stimuli management module 212, the telemetry node management module 236, or the like) may use the master telemetry node 706 to store the retrieved telemetry dataset in association with the slave telemetry node 708. Based on the association of the retrieved telemetry dataset with the slave telemetry node 708, the slave telemetry node 708 may represent the retrieved telemetry dataset associated with the active node 702. The active node 702 may be a source active node for the slave telemetry node 708. Notably, the executable graph-based model 100 may include a plurality of planes (namely, layers, subgraphs). The slave telemetry node 708 may be instantiated in the first plane of the executable graph-based model 100 that may be different from the second plane of the executable graph-based model 100 that may include the active node 702. In some embodiments, the first plane may be dedicated to various slave telemetry nodes instantiated within the executable graph-based model 100. In addition, the second plane may be dedicated to the plurality of active nodes of the executable graph-based model 100. The master telemetry node 706 may act as a link between the slave telemetry node 708 in the first plane and the active node 702 in the second plane.

A node-type of the master telemetry node 706 may be a combination of an edge node-type and an overlay node-type as described in conjunction with FIGS. 4A and 4B. A node-type (for example, the node-type 408) of the slave telemetry node 708 may correspond to a vertex node-type (for example, the vertex node-type 428), an edge node-type (for example, the edge node-type 430), an overlay node-type (for example, the overlay node-type 432), or a role node-type (for example, the role node-type 434) based on a type of the telemetry dataset being represented thereby. For example, the active node 702 may be an overlay node and the retrieved telemetry dataset may be indicative of one or more outputs generated by the active node 702. In such an example, the slave telemetry node 708 may have the vertex node-type.

The node-type (for example, the node-type 408) of the slave telemetry node 708 may correspond to the vertex node-type (for example, the vertex node-type 428), the edge node-type (for example, the edge node-type 430), the overlay node-type (for example, the overlay node-type 432), or the role node-type (for example, the role node-type 434) based on a node-type (for example, the node-type 308) of the active node 702. The active node 702 may have a vertex node-type, an edge node-type, an overlay node-type, or a role node-type as described in conjunction with FIGS. 3A and 3B. Based on the active node 702 having the vertex node-type (for example, the vertex node-type 328), the slave telemetry node 708 may have the vertex node-type. In other words, based on the active node 702 being a vertex node, the slave telemetry node may be a vertex telemetry node. Based on the active node 702 having the edge node-type (for example, the edge node-type 330), the slave telemetry node 708 may have the edge node-type. In other words, based on the active node 702 being an edge node, the slave telemetry node may be an edge telemetry node. Based on the active node 702 having the overlay node-type (for example, the overlay node-type 332), the slave telemetry node 708 may have the overlay node-type. In other words, based on the active node 702 being an overlay node, the slave telemetry node may be an overlay telemetry node. Based on the active node 702 having the role node-type (for example, the role node-type 334), the slave telemetry node 708 may have the role node-type. In other words, based on the active node 702 being a role node, the slave telemetry node may be a role telemetry node.

Subsequently, the processing circuitry (for example, the controller module 206, the transaction module 208, the stimuli management module 212, the telemetry node management module 236, or the like) may identify a telemetry operations overlay node 710 from a plurality of telemetry operations overlay nodes of the executable graph-based model 100. Each telemetry operations overlay node may be associated with a corresponding set of analysis parameters. The set of analysis parameters may refer to constraints, criteria, rule, thresholds, or the like with respect to which a telemetry dataset may be analyzed. Each telemetry operations overlay node may be further associated with a corresponding type of telemetry that may be performed based on execution of processing logic associated therewith. The telemetry operations overlay node 710 may be identified based on a type of telemetry associated therewith being same as the type of telemetry associated with the master telemetry node 706 and/or the stimulus. In addition, the telemetry operations overlay node 710 may be identified based on a set of analysis parameters associated therewith being capable of analyzing the retrieved telemetry dataset. In an example, the set of analysis parameters may be indicative of ‘a delay in loading based on loading time being greater a threshold loading time’ and the retrieved telemetry dataset may include a loading time, the processed on, and the handled on timestamp of the active node 702. Therefore, the retrieved telemetry dataset may be analyzed based on the set of analysis parameters associated with the telemetry operations overlay node 710. In some embodiments, the telemetry operations overlay node 710 may be identified further based on a functionality thereof being in conformity with the stimulus. In other words, processing logic of the telemetry operations overlay node 710 when executed may perform the type of telemetry indicated by the stimulus.

The processing circuitry (for example, the controller module 206, the transaction module 208, the stimuli management module 212, the telemetry node management module 236, or the like) may associate the telemetry operations overlay node 710 with the slave telemetry node 708. The master telemetry node 706 may cause processing logic of the telemetry operations overlay node 710 to be executed on the retrieved telemetry dataset represented by the slave telemetry node 708. Based on such an execution, the master telemetry node 706 may use the telemetry operations overlay node 710 to generate the set of telemetry insights.

In some embodiments, the slave telemetry node 708 may include an overlay manager 708a that may configured to manage the association of the slave telemetry node 708 with the telemetry operations overlay node 710. The overlay manager 708a may have a description that may be similar to the descriptions of the overlay managers 504 or 516.

Notably, the master telemetry node 706 owns the slave telemetry node 708. In other words, the slave telemetry node 708 may be a child node of the master telemetry node 706. In some embodiments, the telemetry operations overlay node 710 may be associated with the master telemetry node 706. Therefore, based on the master telemetry node 706 owning the slave telemetry node 708, the processing logic of the telemetry operations overlay node 710 may be executed on the retrieved telemetry dataset represented by the slave telemetry node 708.

The processing circuitry (for example, the controller module 206, the transaction module 208, the stimuli management module 212, the telemetry node management module 236, or the like) may be further configured to use the master telemetry node 706 and/or the telemetry operations overlay node 710 to generate an insight file 712. The insight file 712 may store the set of telemetry insights generated based on the analysis of the retrieved telemetry dataset. The insight file 712 may be stored in the storage element of the overlay system 202. The insight file 712 may be accessed as and when required by the processing circuitry (for example, the controller module 206, the transaction module 208, the stimuli management module 212, the telemetry node management module 236, or the like) to analyze a current or historical operational performance of the overlay system 202.

In some embodiments, the processing circuitry (for example, the controller module 206, the transaction module 208, the stimuli management module 212, the telemetry node management module 236, or the like) may be further configured to instantiate an insight node 714. The set of telemetry insights may be stored in the storage element in association with the insight node 714. Based on the association with the set of telemetry insights, the insight node 714 may represent the set of telemetry insights in the executable graph-based model 100. In some embodiments, the insight node 714 may be correlated with the active node 702. In such embodiments, a source node ID of the insight node 714 may be same as a unique ID of the active node 702.

In some embodiments, the master telemetry node 706 may be further associated with one or more standard operations overlay nodes (for example, a standard operations overlay node 716) of a plurality of standard operations overlay nodes of the executable graph-based model 100. As shown, the master telemetry node 706 is associated with the standard operations overlay node 716. In such embodiments, the processing circuitry (for example, the controller module 206, the transaction module 208, the stimuli management module 212, the telemetry node management module 236, or the like) may determine the standard operations overlay node 716. The set of telemetry insights may be determined further based on the standard operations overlay node 716. For example, the standard operations overlay node 716 may be an encryption overlay node. In such an example, for determining the set of telemetry insights, an encryption/decryption logic of the standard operations overlay node 716 may be used to decrypt the master telemetry node 706 prior to the retrieval of the telemetry dataset from the active node 702.

In some embodiments, the master telemetry node 706 may be a public access node, a private access node, or a protected access node. Based on the master telemetry node 706 being a public access node of the executable graph-based model 100, the master telemetry node 706 is accessible to all entities or users within the overlay system 202. Based on the master telemetry node 706 being a private access node, the master telemetry node 706 is restricted to be accessible and used by specific users or entities associated with the overlay system 202. Only authorized users or processes can access or interact with the private access node. Based on the master telemetry node 706 being a protected access node falls between public and private access nodes. It is partially restricted, meaning the master telemetry node 706 may be accessible to certain users or under specific conditions. The protected access node may have controlled permissions, such as read-only access for some users while allowing modifications by others. In an example, the standard operations overlay node 716 may be a contract overlay node. In such an example, the standard operations overlay node 716 may include processing logic that when executed may implement one or more constraints for implementing access control of the master telemetry node 706.

In some embodiments, the master telemetry node 706 may include an overlay manager 706a that may configured to manage the association of the master telemetry node 706 with the standard operations overlay node 716 or any other overlay node associated therewith. The overlay manager 706a may have a description that may be similar to the descriptions of the overlay managers 504 or 516.

In some embodiments, the active node 702 may be associated with a standard operations overlay node 718. In such embodiments, the processing circuitry (for example, the controller module 206, the transaction module 208, the stimuli management module 212, the telemetry node management module 236, or the like) may determine the standard operations overlay node 718. The set of telemetry insights may be determined further based on the standard operations overlay node 718. In an example, data associated with the active node 702 may be sensitive and/or confidential. Therefore, the data associated with the active node 702 may be required to be secured. To secure the data associated with the active node 702, the processing circuitry (for example, the controller module 206, the transaction module 208, the overlay management module 238, or the like) may be further configured to associate the standard operations overlay node 718 with the active node 702. The standard operations overlay node 718 may be an encryption overlay node. Therefore, to determine the set of telemetry insights, the processing circuitry (for example, the controller module 206, the transaction module 208, the stimuli management module 212, the telemetry node management module 236, or the like) may decrypt the active node 702 using the standard operations overlay node 718 prior to the retrieval of the telemetry dataset.

In some embodiments, the master telemetry node 706 may be further associated with a master telemetry node 720. In such embodiments, the processing circuitry (for example, the controller module 206, the transaction module 208, the stimuli management module 212, the telemetry node management module 236, or the like) may determine the master telemetry node 720 based on the association thereof with the master telemetry node 706. Based on the association of the master telemetry nodes 706 and 720, the slave telemetry node 708 may be further associated with the master telemetry node 720. The set of telemetry insights may be determined further based on the master telemetry node 720. In some embodiments, the insight file 712 or the insight node 714 may include an intermediate set of telemetry insights. In such embodiments, a final set of telemetry insights may be determined based on the master telemetry node 720. In an example, the intermediate set of telemetry insights may be indicative of an audit report of the operational performance of the overlay system 202 with respect to the active node 702. The master telemetry node 720 may use the intermediate set of telemetry insights to determine the final set of telemetry insights being indicative of a requirement to generate an alert indicative of a performance issue associated with the overlay system 202. The processing circuitry (for example, the controller module 206, the transaction module 208, or the like) may be further configured to instantiate an insight node (not shown) to represent the final set of telemetry insights.

In some embodiments, the master telemetry node 706 may inherit from one or more master telemetry nodes of the plurality of master telemetry nodes of the executable graph-based model 100. As shown, the master telemetry node 706 may inherit from a master telemetry node 722. Although not shown, the master telemetry node 722 may be associated with one or more telemetry operations overlay nodes and/or one or more standard operations overlay nodes. Based on the master telemetry node 706 inheriting the master telemetry node 722, the set of telemetry insights may be determined further based on the master telemetry node 722. In addition, the set of telemetry insights may be determined further based on the one or more telemetry operations overlay nodes and/or the one or more standard operations overlay nodes associated with the master telemetry node 722. In an example, the master telemetry node 722 may be associated with a standard operations overlay node that may be an obfuscation overlay node. In such an example, the set of telemetry insights may be confidential and sensitive. Therefore, the master telemetry node 706 may use the obfuscation overlay node associated with the master telemetry node 722 to obfuscate the set of telemetry insights.

In some embodiments, the active node 702 may be further associated with a master telemetry node 724 of the plurality of master telemetry nodes. In such embodiments, the processing circuitry (for example, the controller module 206, the transaction module 208, or the like) may be further configured to determine the master telemetry node 724 based on the stimulus or association with the active node 702. The set of telemetry insights may be determined further based on the master telemetry node 724. In an example, the stimulus may be indicative of a first type of telemetry ‘latency’ and a second type of telemetry ‘throughput’. The master telemetry node 706 may be associated with the first type of telemetry ‘latency’ and the master telemetry node 724 may be associated with the second type of telemetry ‘throughput’. Therefore, the master telemetry nodes 706 and 724 may be determined based on the stimulus. Subsequently, the master telemetry node 724 may instantiate a slave telemetry node 726 as described previously for instantiation of the slave telemetry node 708. The master telemetry node 724 may associate the slave telemetry node 726 with a telemetry operations overlay node 728. A first additional set of telemetry insights may be determined based on the master telemetry node 724, the slave telemetry node 726, and the telemetry operations overlay node 728 as described above. The set of telemetry insights may be a combination of (i) telemetry insights determined based on the master telemetry nodes 706 and the telemetry dataset retrieved from the active node 702 and (ii) the first additional set of telemetry insights.

In some embodiments, the master telemetry node 706 may be further associated with the active node 704. The processing circuitry (for example, the controller module 206, the transaction module 208, the stimuli management module 212, or the like) may be further configured to determine the active node 704 based on the stimulus. The active node 704 may also be determined based on the association thereof with the master telemetry node 706. In some embodiments, the active node 704 may be correlated with the active node 702, hence the active node 704 may be determined based on correlation thereof with the active node 702. In one example, each of the active nodes 702 and 704 may have a first label. In such an example, the stimulus may be indicative of the first label. Hence, the active node 704 may also be determined based on the stimulus. In another example, the active nodes 702 and 704 may be associated with a first transaction of the overlay system 202. In such an example, the stimulus may be indicative of analysis of the operational performance of the overlay system 202 with respect to the first transaction. Therefore, the active node 704 may also be determined based on the stimulus.

The master telemetry node 706 may instantiate a slave telemetry node 730 that may represent a telemetry dataset retrieved from the active node 704. The master telemetry node 706 may associate the slave telemetry node 730 with a telemetry operations overlay node that may be same as or different from the telemetry operations overlay node 710. For the sake of ongoing description, the slave telemetry node 730 is assumed to be associated with the telemetry operations overlay node 710. Subsequently, a second additional set of telemetry insights may be generated based on the slave telemetry node 730, the master telemetry node 706, and/or the telemetry operations overlay node 710. The set of telemetry insights may be a combination of (i) telemetry insights determined based on the master telemetry nodes 706 and the telemetry dataset retrieved from the active node 702 and (ii) the second additional set of telemetry insights.

In some embodiments, the active node 702 may be a generic node (for example, the generic node 302). Based on the active node 702 being the generic node, each telemetry node (for example, the master telemetry node 706, the slave telemetry node 708, or the like) may be a generic telemetry node. Similarly, various telemetry operations overlay nodes and standard operations overlay nodes may also be generic nodes.

In some embodiments, the active node 702 may be a run-time node (for example, the run-time node 336). Based on the active node 702 being the run-time node, each telemetry node (for example, the master telemetry node 706, the slave telemetry node 708, or the like) may be a run-time telemetry node. Similarly, various telemetry operations overlay nodes and standard operations overlay nodes may also be run-time nodes. In such embodiments, each node may include a node template and a node instance. Therefore, each run-time node may be loaded based on loading of corresponding node template and node instance as described in conjunction with FIG. 6. In such embodiments, each telemetry node may include a telemetry node template and a telemetry node instance. Therefore, each telemetry node (for example, run-time master telemetry node, run-time slave telemetry node, or the like) may be loaded based on loading of corresponding telemetry node template and telemetry node instance as described in conjunction with FIG. 6.

Having discussed implementation of the telemetry nodes in conjunction with active nodes that may be singular nodes (namely, a single node), the description now moves towards implementation of the telemetry nodes in conjunction with active nodes that may be composite nodes.

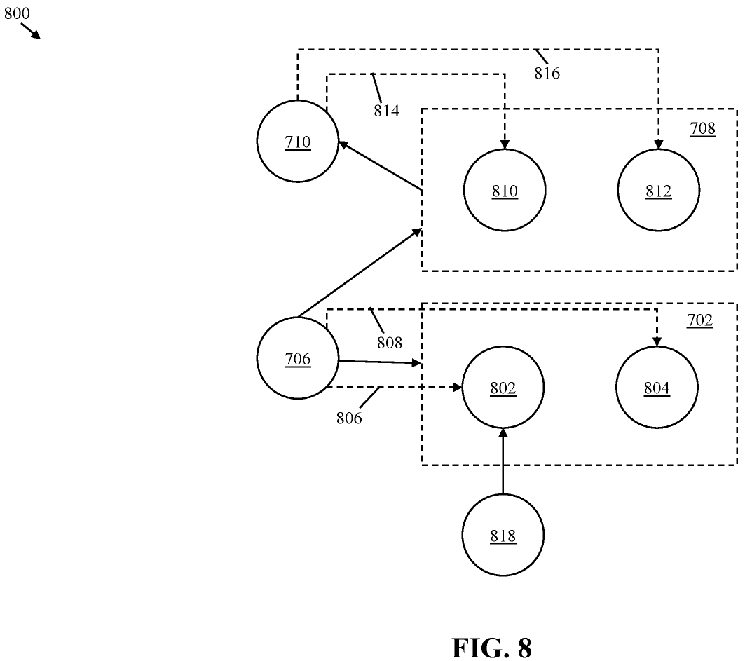

FIG. 8 illustrates a graph 800 that depicts implementation of the plurality of telemetry nodes in conjunction with composite nodes of the executable graph-based model 100, consistent with disclosed embodiments of the present disclosure. Referring to FIG. 8, the graph 800 is shown to include the active node 702. For the sake of description of FIG. 8, the active node 702 is assumed to be a first composite node of a plurality of composite nodes of the executable graph-based model 100. Examples of composite nodes may include sub-graphs, containers, or the like implemented within the executable graph-based model 100 in form of a node. Each composite node of the plurality of composite nodes may include two or more active nodes of the plurality of active nodes of the executable graph-based model 100. The two or more active nodes may be correlated with each other. For the sake of description of FIG. 8, the active node 702 is referred to and depicted as the composite node 702. The composite node 702 is shown to be associated with the master telemetry node 706. In some embodiments, the composite node 702 may have a standard structure that may be similar to a standard structure of a generic node (for example, the generic node 302). In some embodiments, the composite node 702 may have a standard structure that may be similar to a standard structure of a run-time node (for example, the run-time node 336).

As shown, the composite node 702 may include active nodes 802 and 804. To retrieve the telemetry dataset from the composite node 702, the processing circuitry (for example, the controller module 206, the transaction module 208, the stimuli management module 212, the telemetry node management module 236, or the like) may be configured to associate a first anchor point (shown by way of a dashed arrow 806) of the master telemetry node 706 with the active node 802 and a second anchor point (shown by way of a dashed arrow 808) of the master telemetry node 706 with the active node 804. The first anchor point may correspond to a point of contact or a point of association between the master telemetry node 706 and the active node 802. Similarly, the second anchor point may correspond to a point of contact or a point of association between the master telemetry node 706 and the active node 804. The processing circuitry (for example, the controller module 206, the transaction module 208, the stimuli management module 212, the telemetry node management module 236, or the like) may retrieve a first subset of telemetry dataset from the active node 802 via the first anchor point. In addition, the processing circuitry (for example, the controller module 206, the transaction module 208, the stimuli management module 212, the telemetry node management module 236, or the like) may retrieve a second subset of telemetry dataset from the active node 804 via the second anchor point. The first and second subsets of telemetry dataset may be retrieved as described in conjunction with FIG. 7. The first and second subsets of telemetry dataset may collectively form the telemetry dataset retrieved from the composite node 702.

The processing circuitry (for example, the controller module 206, the transaction module 208, the stimuli management module 212, the telemetry node management module 236, or the like) may instantiate the slave telemetry node 708 as a second composite node of the executable graph-based model 100. The slave telemetry node 708 may include a slave telemetry node 810 that may represent the first subset of telemetry dataset. The slave telemetry node 708 may further include a slave telemetry node 812 that may represent the second subset of telemetry dataset. Subsequently, the processing circuitry (for example, the controller module 206, the transaction module 208, the stimuli management module 212, the telemetry node management module 236, or the like) may identify the telemetry operations overlay node 710 and associate the telemetry operations overlay node 710 with the slave telemetry node 708 as described in conjunction with FIG. 7.

Based on association of the telemetry operations overlay node 710 with the slave telemetry node 708, the processing circuitry (for example, the controller module 206, the transaction module 208, the stimuli management module 212, the telemetry node management module 236, or the like) may associate the slave telemetry nodes 810 and 812 with the telemetry operations overlay node 710. The telemetry operations overlay node 710 may be associated with the slave telemetry node 810 via a third anchor point (shown by way of a dashed arrow 814) acting as a point of contact between the telemetry operations overlay node 710 and the slave telemetry node 810. The telemetry operations overlay node 710 may be associated with the slave telemetry node 812 via a fourth anchor point (shown by way of a dashed arrow 816) acting as a point of contact between the telemetry operations overlay node 710 and the slave telemetry node 812. The telemetry operations overlay node 710 may access and analyze the first and second subsets of telemetry dataset via the third and fourth anchor points, respectively. The set of telemetry insights may be determined based on the first and second subsets of telemetry datasets, which collectively form the telemetry dataset, as described in conjunction with FIG. 7.

In some embodiments, the active node 802 may be further associated with a master telemetry node 818. The processing circuitry (for example, the controller module 206, the transaction module 208, the stimuli management module 212, the telemetry node management module 236, or the like) may determine the master telemetry node 818 based on the stimulus and/or the association thereof with the active node 802 included in the composite node 702. Subsequently, the set of telemetry insights may be determined further based on the master telemetry node 818 as described in conjunction with FIG. 7. The processing circuitry (for example, the controller module 206, the transaction module 208, the telemetry node management module 236, or the like) may be further configured to store the set of telemetry insights in association with the composite node 702.

In some embodiments, the active node 802 may include confidential data that may not be accessible to the master telemetry node 706. In such embodiments, the processing circuitry (for example, the controller module 206, the transaction module 208, the stimuli management module 212, the telemetry node management module 236, or the like) may determine the master telemetry node 818 which may override the master telemetry node 706. The master telemetry node 818 may access the active node 802 to retrieve the first subset of telemetry dataset. The master telemetry node 818 may perform analysis of the first subset of telemetry dataset as described throughout the description.

Thus, the plurality of telemetry nodes may allow real-time generation of the set of telemetry insights associated with the overlay system 202 at node-level. The set of telemetry insights enable real-time monitoring of the operational performance of the overlay system 202. The set of telemetry insights may be used by the processing circuitry (for example, the controller module 206, the transaction module 208, the telemetry node management module 236, or the like) to identify trends, patterns, or recurring issues over an extended period within the overlay system 202.

Notably, the analysis of the telemetry dataset may be a descriptive analysis, a diagnostic analysis, a predictive analysis, or a prescriptive analysis. Based on the analysis being the descriptive analysis, the set of telemetry insights may be indicative of ‘what happened’ within the overlay system 202. Based on the analysis being the diagnostic analysis, the set of telemetry insights may be indicative of ‘why it happened’ within the overlay system 202. Based on the analysis being the predictive analysis, the set of telemetry insights may be indicative of ‘what is likely to happen’ within the overlay system 202. Based on the analysis being the prescriptive analysis, the set of telemetry insights may be indicative of ‘what should be done’ based on a current operational performance of the overlay system 202.

It will be apparent to a person skilled in the art that an operation performed by a node (for example, a master telemetry node, a slave telemetry node, a standard operations overlay node, a telemetry operations overlay node) is executed by one or more modules (shown in FIG. 2) of the overlay system 202 while using the node.

Various embodiments and concepts, for the implementation of the plurality of telemetry nodes in conjunction with singular nodes, described in conjunction with FIG. 7 are further applicable for the implementation of the plurality of telemetry nodes in conjunction with composite nodes described in conjunction with FIG. 8.

It should be appreciated that the references to ‘first active node’ and ‘second active node,’ or other similar terms in the claims are not intended to refer to specific nodes but are used for distinguishing elements. These nodes may correspond to any of the generic nodes and/or run-time nodes described in the specification, including, but not limited to, the active nodes 702 and 704, or any other applicable active node discussed throughout the description.

It should be appreciated that the references to ‘first master telemetry node,’ ‘second master telemetry node,’ or other similar terms in the claims are not intended to refer to specific master telemetry nodes but are used for distinguishing elements. These nodes may correspond to any of the master telemetry nodes described in the specification, including, but not limited to, the master telemetry nodes 706 and 720, or any other applicable telemetry node discussed herein.

FIG. 9 shows an example computing system 900 for carrying out the methods of the present disclosure, consistent with disclosed embodiments of the present disclosure. Specifically, FIG. 9 shows a block diagram of an embodiment of the computing system 900 according to example embodiments of the present disclosure.

The computing system 900 may be configured to perform any of the operations disclosed herein, such as, for example, any of the operations discussed with reference to the functional modules described in relation to FIG. 2. The computing system 900 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 900 is a distributed system configured to function using multiple computing machines interconnected via a data network or bus system.

The computing system 900 includes computing devices (such as a computing device 902). The computing device 902 includes one or more processors (such as a processor 904) and a memory 906. The processor 904 may be any general-purpose processor(s) configured to execute a set of instructions. For example, the processor 904 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 904 may be multiple processing units, a single processing core, multiple processing cores, special purpose processing cores, co-processors, or any combination thereof. The processor 904 may be communicatively coupled to the memory 906 via an address bus 908, a control bus 910, a data bus 912, and a messaging bus 914.

The memory 906 may include non-volatile memories such as a read-only memory (ROM), a programable read-only memory (PROM), an erasable programmable read-only memory (EPROM), a flash memory, or any other device capable of storing program instructions or data with or without applied power. The memory 906 may also include volatile memories, such as a random-access memory (RAM), a static random-access memory (SRAM), a dynamic random-access memory (DRAM), and a synchronous dynamic random-access memory (SDRAM). The memory 906 may include single or multiple memory modules. While the memory 906 is depicted as part of the computing device 902, a person skilled in the art will recognize that the memory 906 can be separate from the computing device 902.

The memory 906 may store information that can be accessed by the processor 904. For instance, the memory 906 (e.g., one or more non-transitory computer-readable storage mediums, memory devices) may include computer-readable instructions (not shown) that can be executed by the processor 904. The computer-readable instructions may be software written in any suitable programming language or may be implemented in hardware. Additionally, or alternatively, the computer-readable instructions may be executed in logically and/or virtually separate threads on the processor 904. For example, the memory 906 may store instructions (not shown) that when executed by the processor 904 cause the processor 904 to perform operations such as any of the operations and functions for which the computing system 900 is configured, as described herein. Additionally, or alternatively, the memory 906 may store data (not shown) that can be obtained, received, accessed, written, manipulated, created, and/or stored. The data can include, for instance, the data and/or information described herein in relation to FIGS. 1-8. In some implementations, the computing device 902 may obtain from and/or store data in one or more memory device(s) that are remote from the computing system 900.

The computing device 902 may further include an input/output (I/O) interface 916 communicatively coupled to the address bus 908, the control bus 910, and the data bus 912. The data bus 912 and messaging bus 914 may include a plurality of tunnels that may support parallel execution of messages by the overlay system 202. The I/O interface 916 is configured to couple to one or more external devices (e.g., to receive and send data from/to one or more external devices). Such external devices, along with the various internal devices, may also be known as peripheral devices. The I/O interface 916 may include both electrical and physical connections for operably coupling the various peripheral devices to the computing device 902. The I/O interface 916 may be configured to communicate data, addresses, and control signals between the peripheral devices and the computing device 902. The I/O interface 916 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 916 is configured to implement only one interface or bus technology. Alternatively, the I/O interface 916 is configured to implement multiple interfaces or bus technologies. The I/O interface 916 may include one or more buffers for buffering transmissions between one or more external devices, internal devices, the computing device 902, or the processor 904. The I/O interface 916 may couple the computing device 902 to various input devices, including mice, touch screens, scanners, biometric readers, electronic digitizers, sensors, receivers, touchpads, trackballs, cameras, microphones, keyboards, any other pointing devices, or any combinations thereof. The I/O interface 916 may couple the computing device 902 to various output devices, including video displays, speakers, printers, projectors, tactile feedback devices, automation control, robotic components, actuators, motors, fans, solenoids, valves, pumps, transmitters, signal emitters, lights, and so forth.

The computing system 900 may further include a storage unit 918, a network interface 920, an input controller 922, and an output controller 924. The storage unit 918, the network interface 920, the input controller 922, and the output controller 924 are communicatively coupled to the central control unit (e.g., the memory 906, the address bus 908, the control bus 910, and the data bus 912) via the I/O interface 916. The network interface 920 communicatively couples the computing system 900 to one or more networks such as wide area networks (WAN), local area networks (LAN), intranets, the Internet, wireless access networks, wired networks, mobile networks, telephone networks, optical networks, or combinations thereof. The network interface 920 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 918 is a computer-readable medium, preferably a non-transitory computer-readable medium, comprising one or more programs, the one or more programs comprising instructions which when executed by the processor 904 cause the computing system 900 to perform the method steps of the present disclosure. Alternatively, the storage unit 918 is a transitory computer-readable medium. The storage unit 918 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 918 stores one or more operating systems, application programs, program modules, data, or any other information. The storage unit 918 is part of the computing device 902. Alternatively, the storage unit 918 is part of one or more other computing machines that are in communication with the computing device 902, such as servers, database servers, cloud storage, network attached storage, and so forth.

The input controller 922 may include suitable logic, circuitry, interfaces, and/or code, executable by the circuitry, that may be configured to control one or more input devices that may be configured to receive an input (the stimulus 230) for the overlay system 202. The output controller 924 may include suitable logic, circuitry, interfaces, and/or code, executable by the circuitry, that may be configured to control one or more output devices that may be configured to render/output the outcome of the operation executed to process the received input (the stimulus 230).

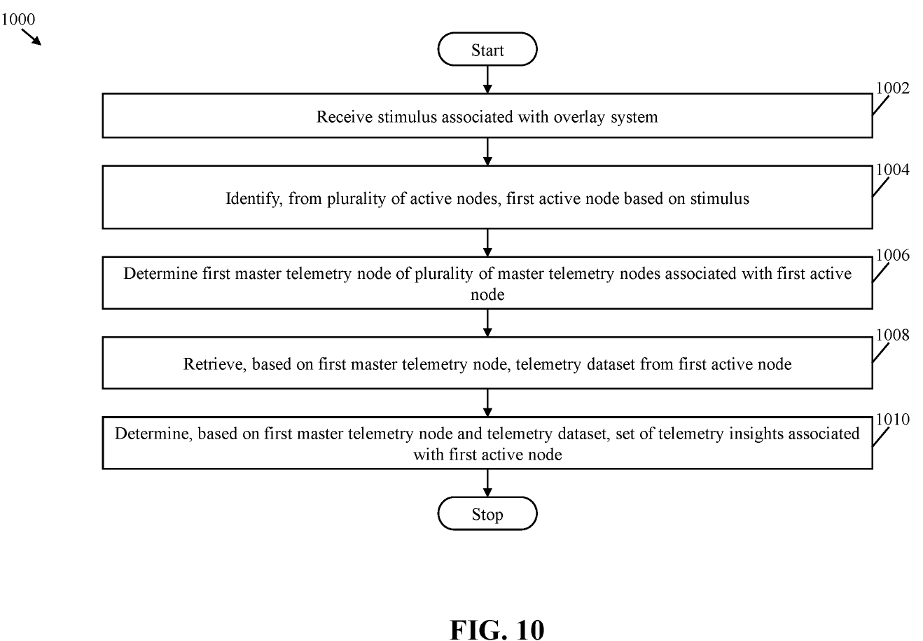

FIG. 10 illustrates a flowchart 1000 of a method for implementing the plurality of telemetry nodes in the executable graph-based model 100, consistent with disclosed embodiments of the present disclosure. Referring to FIG. 10, at 1002, a stimulus is received. The processing circuitry (such as the controller module 206, the stimuli management module 212, or the like) may be configured to receive the stimulus associated with the overlay system 202.

At 1004, based on the stimulus, a first active node (for example, the active node 702) of the plurality of active nodes may be identified. The processing circuitry (for example, the controller module 206, the context module 210, the stimuli management module 212, or the like) may be configured to determine the first active node from the plurality of active nodes.

At 1006, a first master telemetry node (for example, the master telemetry node 706) of the plurality of master telemetry nodes associated with the first active node may be determined. The processing circuitry (for example, the controller module 206, the context module 210, the telemetry node management module 236, or the like) may be configured to determine the first master telemetry node associated with the first active node.

At 1008, using the first master telemetry node, a telemetry dataset from the first active node may be retrieved. The processing circuitry (for example, the controller module 206, the context module 210, and the telemetry node management module 236) may be configured to retrieve the telemetry dataset, using the first master telemetry node, associated with the first active node.

At 1010, a set of telemetry insights may be determined based on the first master telemetry node and the telemetry dataset. The processing circuitry (for example, the controller module 206, the transaction module 208, or the like) may determine the set of telemetry insights based on the first master telemetry node and the telemetry dataset associated with the first active node. The set of telemetry insights may be indicative of an operational performance of the overlay system 202.

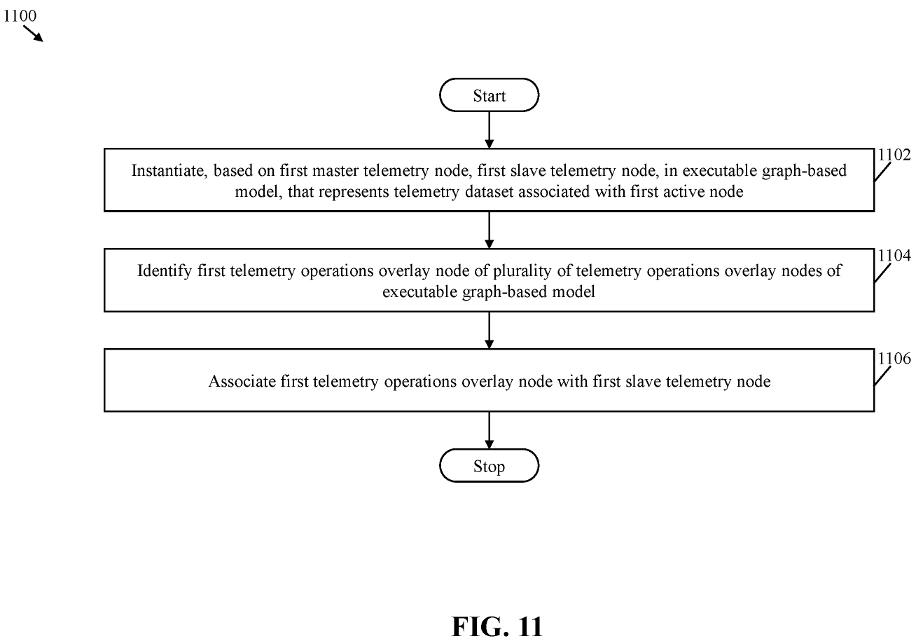

FIG. 11 illustrates a flowchart 1100 of a method for determining the set of telemetry insights, consistent with disclosed embodiments of the present disclosure. Referring to FIG. 11, at 1102, a first slave telemetry node (for example, the slave telemetry node 708) that represents a telemetry dataset associated with the first active node may be instantiated in the executable graph-based model 100. The processing circuitry (for example, the controller module 206, the context module 210, and the telemetry node management module 236) may be configured to instantiate the first slave telemetry node based on the first master telemetry node (for example, the master telemetry node 706).

At 1104, a first telemetry operations overlay node (for example, the telemetry operations overlay node 710) of a plurality of telemetry operations overlay nodes of the executable graph-based model 100 may be identified. The processing circuitry (for example, the controller module 206, the context module 210, the telemetry node management module 236, or the like) may be configured to identify the first telemetry operations overlay node (for example, the telemetry operations overlay node 710) of the plurality of telemetry operations overlay nodes.

At 1106, the first telemetry operations overlay node may be associated with the first slave telemetry node. The processing circuitry (for example, the controller module 206, the context module 210, and the telemetry node management module 236) may be configured to associate the first telemetry operations overlay node with the first slave telemetry node. A set of telemetry insights may be determined based on an execution of processing logic of the first telemetry operations overlay node on the telemetry dataset represented by the first slave telemetry node.

The disclosed embodiments encompass numerous advantages including a simple and user-friendly implementation of the executable graph-based model 100 that may be in turn used to implement various complex and advanced applications. Further, the disclosed systems and methods allow for the facilitation of telemetry nodes in the executable graph-based model 100. The disclosed overlay system 202 eliminates the challenges associated with extracting and analyzing operational data associated with graph-based models. The disclosed overlay system 202 offers real-time performance monitoring, significantly enhanced computational efficiency, and low-latency decision-making, making it highly suitable for time-sensitive applications such as fraud detection, cybersecurity, autonomous systems, or the like. The disclosed overlay system 202 enables instantaneous operational data extraction and continuous analysis, ensuring that insights are generated in real-time. Such analysis of the operational data is performed at the node-level. Hence, performance of the overlay system 202 with respect to each node may be analyzed and optimized.

Additionally, the disclosed overlay system 202 improves energy efficiency, reduces costs, and minimizes resource wastage by identifying and eliminating bottlenecks associated with various operations. The overlay system 202 exhibits adaptive, self-optimizing capabilities that ensure minimal manual intervention while maintaining high accuracy and reliability in performance analytics. Seamless integration with existing graph-based frameworks and compliance with security standards further enhance its usability across diverse industries, including AI-driven analytics, recommendation systems, and real-time monitoring solutions. Ultimately, the disclosed overlay system 202 provides a robust, scalable, and future-proof solution for maximizing the potential of the graph-based models while ensuring optimal system performance.

Notably, application areas of the telemetry nodes may include, but are not limited to, data visualization based on sets of telemetry insights, real-time performance monitoring, threshold monitoring and alert generation for various thresholds associated with the overlay system 202, historical performance analysis of the overlay system 202, data analysis associated with the overlay system 202, enable remote control and remote decision-making capabilities for the overlay system 202, security monitoring for the overlay system 202, performance optimization of the overlay system 202, compliance and reporting of such compliance for the overlay system 202, seamless and convenient user interaction.

Additionally, the telemetry dataset may be collected to facilitate various operations including but not limited to, data collection, data aggregation, data filtering, data transformation, data storage, real-time monitoring, anomaly detection, performance monitoring, fault detection and diagnosis, capacity planning, predictive maintenance, environmental monitoring, energy consumption analysis, security monitoring, data visualization, alerting and notifications, compliance monitoring, location tracking, network monitoring, and quality of service (QoS) monitoring.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems, and methods for facilitating implementation of telemetry nodes in executable graph-based models. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:

1. An overlay system, comprising:

a storage element configured to store an executable graph-based model that includes a plurality of active nodes and a plurality of master telemetry nodes; and

processing circuitry that is coupled to the storage element, and configured to:

receive a stimulus associated with the overlay system;

identify, from the plurality of active nodes, a first active node based on the stimulus;

determine a first master telemetry node of the plurality of master telemetry nodes associated with the first active node;

retrieve, based on the first master telemetry node, a telemetry dataset from the first active node; and

2. The overlay system of 1, wherein a node-type of the first master telemetry node is combination of an edge node-type and an overlay node-type.

3. The overlay system of 1,

wherein the executable graph-based model further includes a plurality of telemetry operations overlay nodes, and

wherein the processing circuitry is further configured to:

instantiate, based on the first master telemetry node, a first slave telemetry node, in the executable graph-based model, that represents the telemetry dataset associated with the first active node;

identify a first telemetry operations overlay node of the plurality of telemetry operations overlay nodes of the executable graph-based model, wherein the first telemetry operations overlay node is identified based on a functionality thereof being in conformity with the stimulus; and

4. The overlay system of 3,

wherein the first active node is one of: a vertex node, an edge node, an overlay node, or a role node,

wherein the first slave telemetry node is one of: a vertex telemetry node, an edge telemetry node, an overlay telemetry node, or a role telemetry node,

wherein based on the first active node being the vertex node, the first slave telemetry node is the vertex telemetry node,

wherein based on the first active node being the edge node, the first slave telemetry node is the edge telemetry node,

wherein based on the first active node being the overlay node, the first slave telemetry node is the overlay telemetry node, and

5. The overlay system of 1, wherein the first active node corresponds to a first composite node that includes a second active node and a third active node, of the plurality of active nodes.

6. The overlay system of 5, wherein the telemetry dataset includes a first subset of telemetry dataset associated with the second active node and a second subset of telemetry dataset associated with the third active node.

7. The overlay system of 6,

wherein the executable graph-based model further includes a plurality of telemetry operations overlay nodes,

wherein the processing circuitry is further configured to:

instantiate, based on the first master telemetry node, a first slave telemetry node in the executable graph-based model, wherein the first slave telemetry node corresponds to a second composite node that includes a second slave telemetry node that represents the first subset of telemetry dataset and a third slave telemetry node that represents the second subset of telemetry dataset;

identify a first telemetry operations overlay node of the plurality of telemetry operations overlay nodes, wherein the first telemetry operations overlay node is identified based on a functionality thereof being in conformity with the stimulus; and

associate, the first telemetry operations overlay node with the first slave telemetry node, and

8. The overlay system of 7,

wherein the processing circuitry is further configured to associate the first telemetry operations overlay node with each of the second slave telemetry node and the third slave telemetry node, and

9. The overlay system of 5,

wherein the second active node is associated with a second master telemetry node of the plurality of master telemetry nodes, and

10. The overlay system of 3,

wherein the first master telemetry node is further associated with a third master telemetry node of the plurality of master telemetry nodes,

wherein based on the association of the first master telemetry node with the third master telemetry node, the first slave telemetry node is further associated with the third master telemetry node, and

11. The overlay system of 1, wherein the processing circuitry is further configured to:

generate an insight file based on the set of telemetry insights; and

12. The overlay system of 1, wherein the processing circuitry is further configured to instantiate an insight node in the executable graph-based model that represents the set of telemetry insights.

13. The overlay system of 1,

wherein the executable graph-based model further includes a plurality of standard operations overlay nodes,

wherein the processing circuitry is further configured to determine a first standard operations overlay node, of the plurality of standard operations overlay nodes, associated with the first master telemetry node, and

14. The overlay system of 1,

wherein the executable graph-based model further includes a plurality of standard operations overlay nodes,

wherein the processing circuitry is further configured to determine a second standard operations overlay node, of the plurality of standard operations overlay nodes, associated with the first active node, and

15. The overlay system of 1, wherein the first master telemetry node is one of: a public access node, a private access node, or a protected access node.

16. The overlay system of 1,

wherein the processing circuitry is further configured to determine a fourth master telemetry node of the plurality of master telemetry nodes associated with the first active node, and

17. The overlay system of 1,

wherein the processing circuitry is further configured to determine a second active node of the plurality of active nodes based on the stimulus,

wherein the first master telemetry node is further associated with the second active node, and

18. The overlay system of 1, wherein the first active node is a generic node and the first master telemetry node is a generic master telemetry node.

19. The overlay system of 1, wherein the processing circuitry is further configured to:

determine, based on the stimulus, whether at least one of the first active node or the first master telemetry node is unloaded from the executable graph-based model; and

20. The overlay system of 1,

wherein the first active node corresponds to a run-time node that includes (i) a node template that defines a node structure and (ii) a node instance that is an implementation of the node template, and

21. The overlay system of 20,

wherein the run-time node is loaded based on loading of the node template and the node instance, and

22. A method, comprising:

receiving, by processing circuitry of an overlay system, a stimulus associated with the overlay system,

wherein an executable graph-based model is stored in a storage element of the overlay system, and

wherein the executable graph-based model includes a plurality of active nodes and a plurality of master telemetry nodes;

identifying, by the processing circuitry, from the plurality of active nodes, a first active node based on the stimulus;

determining, by the processing circuitry, a first master telemetry node of the plurality of master telemetry nodes associated with the first active node;

retrieving, by the processing circuitry, based on the first master telemetry node, a telemetry dataset from the first active node; and

determining, by the processing circuitry, based on the first master telemetry node and the telemetry dataset, a set of telemetry insights associated with the first active node, wherein the set of telemetry insights is indicative of one or more operational parameters associated with the overlay system.

What is claimed is:

1. An overlay system, comprising:
a storage element configured to store an executable graph-based model that includes a plurality of active nodes and a plurality of master telemetry nodes; and
processing circuitry that is coupled to the storage element, and configured to:
receive a stimulus associated with the overlay system;
identify, from the plurality of active nodes, a first active node based on the stimulus;
determine a first master telemetry node of the plurality of master telemetry nodes associated with the first active node;
retrieve, based on the first master telemetry node, a telemetry dataset from the first active node; and
determine, based on the first master telemetry node and the telemetry dataset, a set of telemetry insights associated with the first active node, wherein the set of telemetry insights is indicative of one or more operational parameters associated with the overlay system.

2. The overlay system of claim 1, wherein a node-type of the first master telemetry node is a combination of an edge node-type and an overlay node-type.

3. The overlay system of claim 1,
wherein the executable graph-based model further includes a plurality of telemetry operations overlay nodes, and
wherein the processing circuitry is further configured to:
instantiate, based on the first master telemetry node, a first slave telemetry node, in the executable graph-based model, that represents the telemetry dataset associated with the first active node;
identify a first telemetry operations overlay node of the plurality of telemetry operations overlay nodes of the executable graph-based model, wherein the first telemetry operations overlay node is identified based on a functionality thereof being in conformity with the stimulus; and
associate the first telemetry operations overlay node with the first slave telemetry node, wherein the set of telemetry insights is determined further based on the first telemetry operations overlay node and the first slave telemetry node.

4. The overlay system of claim 3,
wherein the first active node is one of: a vertex node, an edge node, an overlay node, or a role node,
wherein the first slave telemetry node is one of: a vertex telemetry node, an edge telemetry node, an overlay telemetry node, or a role telemetry node,
wherein based on the first active node being the vertex node, the first slave telemetry node is the vertex telemetry node,
wherein based on the first active node being the edge node, the first slave telemetry node is the edge telemetry node,
wherein based on the first active node being the overlay node, the first slave telemetry node is the overlay telemetry node, and
wherein based on the first active node being the role node, the first slave telemetry node is the role telemetry node.

5. The overlay system of claim 1, wherein the first active node corresponds to a first composite node that includes a second active node and a third active node, of the plurality of active nodes.

6. The overlay system of claim 5, wherein the telemetry dataset includes a first subset of telemetry dataset associated with the second active node and a second subset of telemetry dataset associated with the third active node.

7. The overlay system of claim 6,
wherein the executable graph-based model further includes a plurality of telemetry operations overlay nodes, and
wherein the processing circuitry is further configured to:
instantiate, based on the first master telemetry node, a first slave telemetry node in the executable graph-based model, wherein the first slave telemetry node corresponds to a second composite node that includes a second slave telemetry node that represents the first subset of telemetry dataset and a third slave telemetry node that represents the second subset of telemetry dataset;
identify a first telemetry operations overlay node of the plurality of telemetry operations overlay nodes, wherein the first telemetry operations overlay node is identified based on a functionality thereof being in conformity with the stimulus; and
associate, the first telemetry operations overlay node with the first slave telemetry node, wherein the set of telemetry insights is determined further based on the first telemetry operations overlay node and the first slave telemetry node.

8. The overlay system of claim 7,
wherein the processing circuitry is further configured to associate the first telemetry operations overlay node with each of the second slave telemetry node and the third slave telemetry node, and
wherein the set of telemetry insights is determined further based on the second slave telemetry node and the third slave telemetry node.

9. The overlay system of claim 5,
wherein the second active node is associated with a second master telemetry node of the plurality of master telemetry nodes, and
wherein the set of telemetry insights is determined further based on the second master telemetry node.

10. The overlay system of claim 3,
wherein the first master telemetry node is further associated with a third master telemetry node of the plurality of master telemetry nodes,
wherein based on the association of the first master telemetry node with the third master telemetry node, the first slave telemetry node is further associated with the third master telemetry node, and
wherein the set of telemetry insights is determined further based on the third master telemetry node.

11. The overlay system of claim 1, wherein the processing circuitry is further configured to:
generate an insight file based on the set of telemetry insights; and
store the insight file, in the storage element, in association with the first active node.

12. The overlay system of claim 1, wherein the processing circuitry is further configured to instantiate an insight node, that represents the set of telemetry insights, in the executable graph-based model.

13. The overlay system of claim 1,
wherein the executable graph-based model further includes a plurality of standard operations overlay nodes,
wherein the processing circuitry is further configured to determine a first standard operations overlay node, of the plurality of standard operations overlay nodes, associated with the first master telemetry node, and
wherein the set of telemetry insights is determined further based on the first standard operations overlay node.

14. The overlay system of claim 1,
wherein the executable graph-based model further includes a plurality of standard operations overlay nodes,
wherein the processing circuitry is further configured to determine a second standard operations overlay node, of the plurality of standard operations overlay nodes, associated with the first active node, and
wherein the set of telemetry insights is determined further based on the second standard operations overlay node.

15. The overlay system of claim 1,
wherein the processing circuitry is further configured to determine a fourth master telemetry node of the plurality of master telemetry nodes associated with the first active node, and
wherein the set of telemetry insights is determined further based on the fourth master telemetry node.

16. The overlay system of claim 1,
wherein the processing circuitry is further configured to determine a second active node of the plurality of active nodes based on the stimulus,
wherein the first master telemetry node is further associated with the second active node, and
wherein the set of telemetry insights is determined further based on the second active node.

17. The overlay system of claim 1, wherein the processing circuitry is further configured to:
determine, based on the stimulus, whether at least one of the first active node or the first master telemetry node is unloaded from the executable graph-based model; and
load at least one of the first active node or the first master telemetry node in the executable graph-based model based on at least one of the first active node or the first master telemetry node being unloaded from the executable graph-based model.

18. The overlay system of claim 1,
wherein the first active node corresponds to a run-time node that includes (i) a node template that defines a node structure and (ii) a node instance that is an implementation of the node template, and
wherein based on the first active node being the run-time node, the first master telemetry node corresponds to a run-time master telemetry node that includes (i) a telemetry node template that defines a telemetry node structure and (ii) a telemetry node instance that is an implementation of the telemetry node template.

19. The overlay system of claim 18,
wherein the run-time node is loaded based on loading of the node template and the node instance, and
wherein the run-time master telemetry node is loaded based on loading of the telemetry node template and the telemetry node instance.

20. A method, comprising:
receiving, by processing circuitry of an overlay system, a stimulus associated with the overlay system,
wherein an executable graph-based model is stored in a storage element of the overlay system, and
wherein the executable graph-based model includes a plurality of active nodes and a plurality of master telemetry nodes;
identifying, by the processing circuitry, from the plurality of active nodes, a first active node based on the stimulus;
determining, by the processing circuitry, a first master telemetry node of the plurality of master telemetry nodes associated with the first active node;
retrieving, by the processing circuitry, based on the first master telemetry node, a telemetry dataset from the first active node; and
determining, by the processing circuitry, based on the first master telemetry node and the telemetry dataset, a set of telemetry insights associated with the first active node, wherein the set of telemetry insights is indicative of one or more operational parameters associated with the overlay system.
